(19) United States
(12) Patent Application Publication
(10) Pub. No.: US 2023/0340309 A1
(43) Pub. Date: Oct. 26, 2023

(54) LOW STRESS LOCA ADDITIVE AND LOCA PROCESSING FOR BONDING OPTICAL SUBSTRATES

(71) Applicant: Meta Platforms Technologies, LLC, Menlo Park, CA (US)

(72) Inventors: Alejo LIFSCHITZ ARRIBIO, Redmond, WA (US); Anthony PHAN, Redmond, WA (US); Austin LANE, Snohomish, WA (US)

(21) Appl. No.: 18/125,618

(22) Filed: Mar. 23, 2023

Related U.S. Application Data
(60) Provisional application No. 63/333,243, filed on Apr. 21, 2022.

(51) Int. Cl. C09J 163/00; G02B 27/01; F21V 8/00; C09J 11/06; C09J 5/00; C08G 59/30; C08G 59/22; B32B 7/12; B32B 17/06; B32B 37/12

(52) U.S. Cl. CPC C09J 163/00; G02B 27/0172; G02B 6/0076; C09J 11/06; C09J 5/00; C08G 59/306; C08G 59/223; B32B 7/12; B32B 17/06; B32B 37/1284; G02B 2027/0123; G02B 2027/0178; C09J 2400/146; C09J 2463/00; B32B 2307/7375; B32B 2255/26; B32B 2037/1253; B32B 2315/08; B32B 2250/40; B32B 2307/412; B32B 2457/20; B32B 2551/00

(57) ABSTRACT

A liquid optically clear adhesive (LOCA) for bonding optical substrates includes siloxane and epoxy-containing oligomers, a UV-activated photo-acid generator, a cross-linker additive, a solvent; and a reactive plasticizer, such as an additive of Structure 1. In one example, the additive of Structure 1 constitutes about 1-7% of a total mass of the LOCA excluding the solvent. R₁, R₂, and R₃ of Structure 1 include methoxide, ethoxide, propoxide, or a combination thereof. R₄ of Structure 1 includes an alkyl chain that is linear or branched and includes 2-8 carbons. The LOCA material is characterized by a refractive index equal to or greater than about 1.6 at 450 nm and an optical absorption below about 0.1% per micrometer of a thickness of the LOCA material.

### CROSS-REFERENCE TO RELATED APPLICATION

This application claims the benefit of and priority to U.S. Provisional Application No. 63/333,243, filed Apr. 21, 2022, entitled “LOW STRESS LOCA ADDITIVE AND LOCA PROCESSING FOR BONDING OPTICAL SUBSTRATES,” which is herein incorporated by reference in its entirety for all purposes.

### BACKGROUND

An artificial reality system, such as a head-mounted display (HMD) or heads-up display (HUD) system, generally includes a near-eye display (e.g., in the form of a headset or a pair of glasses) configured to present content to a user via an electronic or optic display within, for example, about 10-20 mm in front of the user's eyes. The near-eye display may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment by, for example, seeing through transparent display glasses or lenses (often referred to as optical see-through).

One example of an optical see-through AR system may use a waveguide-based optical display, where light of projected images may be coupled into a waveguide (e.g., a transparent substrate), propagate within the waveguide, and be coupled out of the waveguide at different locations. In some implementations, the light of the projected images may be coupled into or out of the waveguide using diffractive optical elements, such as surface-relief gratings (SRGs) or volume Bragg gratings (VBGs). Light from the surrounding environment may pass through a see-through region of the waveguide and reach the user's eyes as well.

In waveguide-based optical display systems, some optical components (e.g., substrates with optical elements formed thereon, such as light sources, gratings, micro-lenses, or liquid crystal structures) may be bonded together to form a waveguide display. To achieve a desired performance, the flatness of the bonding layers and the bonded structure may need to be precisely controlled. For example, the two opposing external surfaces of a layer stack including two or more flat substrates bonded together may need to maintain a high degree of parallelism, and the layer stack may need to have a minimal total thickness variation (TTV) and a low bowing.

### SUMMARY

This disclosure relates generally to techniques for bonding optical components. More specifically, disclosed herein are techniques for bonding optical substrates (with or without optical components formed thereon) using liquid optically clear adhesives (LOCAs) to achieve a controlled thickness and a low bowing in the bonded devices. Various inventive embodiments are described herein, including devices, systems, methods, processes, materials, mixtures, compositions, and the like.

According to some embodiments, a LOCA for bonding optical substrates may include siloxane and epoxy-containing oligomers, a UV-activated photo-acid generator, a cross-linker additive, a solvent, and an additive of Structure 1:

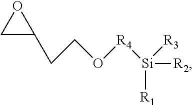

where the additive of Structure 1 may constitute about 1-7% of a total mass of the LOCA excluding the solvent. R₁, R₂, and R₃ may include methoxide, ethoxide, propoxide, or a combination thereof. R₄ may include an alkyl chain that is linear or branched and includes 2-8 carbons, such as linear C₆H₁₂. When cured, the LOCA may have a refractive index equal to or greater than about 1.6 at 450 nm and an optical absorption below about 0.1% per micrometer of a thickness of the LOCA. The LOCA may be curable by ultraviolet light, heat, or both ultraviolet light and heat. The LOCA, when applied onto two 4- to 8-inch substrates and cured, may yield a bonded stack with a bow below about 20 micrometers. The LOCA, when applied onto two glass substrates and cured, may yield a bonded substrate stack with a lap shear strength greater than about 1.5 MPa.

According to some embodiments, a method may include coating, on a first transparent substrate, a layer of a liquid optically clear adhesive (LOCA) material that includes a solvent and an additive of Structure 1 described above; bonding a second transparent substrate to the layer of the LOCA material (e.g., by compression) to form a substrate stack; curing the substrate stack using ultraviolet (UV) light to crosslink the LOCA material; and thermally curing the substrate stack to transform the LOCA material into a thermoset state. The LOCA material may include a siloxane-containing epoxy adhesive. The additive of Structure 1 may constitute about 1-7% of a total mass of the LOCA material. A thickness of the layer of the LOCA material may be between about 1 and about 100 microns. After thermally curing the substrate stack, the layer of the LOCA material may be characterized by a refractive index equal to or greater than about 1.6 at 450 nm and an optical absorption below about 0.1% per micrometer of a thickness of the layer of the LOCA material, and the substrate stack may be characterized by a lap shear strength greater than about 1.5 Mpa. In some embodiments, the first transparent substrate and the second transparent substrate may be substrates with diameters between about 4 and about 8 inches, and a bow of the substrate stack may be less than about 20 μm after thermally curing the substrate stack.

According to some embodiments, a device may include a layer stack comprising two transparent substrates bonded together by a siloxane-containing epoxy adhesive layer, where the siloxane-containing epoxy adhesive layer may include an additive of Structure 1 described above, and the additive of Structure 1 may constitute about 1-7% of a total mass of the siloxane-containing epoxy adhesive layer. The siloxane-containing epoxy adhesive layer may be characterized by a refractive index equal to or greater than about 1.6 at 450 nm and an optical absorption below about 0.1% per micrometer of a thickness of the siloxane-containing epoxy adhesive layer. A thickness of the siloxane-containing epoxy adhesive layer may be between about 1 and 100 microns, and the layer stack may be characterized by a lap shear strength greater than about 1.5 MPa. In some embodiments, the two transparent substrates are substrates with diameters between 4 and 8 inches, and a bow of the layer stack is less than about 20 μm. In some embodiments, at least one of two transparent substrates is a lens of an arbitrary shape and with a length of about 1 to 4 inches, and a bow of the layer stack is less than about 10 μm.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 is a simplified block diagram of an example of an artificial reality system environment including a near-eye display according to certain embodiments.

FIG. 2 is a perspective view of an example of a near-eye display in the form of a head-mounted display (HMD) device for implementing some of the examples disclosed herein.

FIG. 3 is a perspective view of an example of a near-eye display in the form of a pair of glasses for implementing some of the examples disclosed herein.

FIG. 4 illustrates an example of an optical see-through augmented reality system including a waveguide display according to certain embodiments.

FIG. 5 illustrates an example of an optical see-through augmented reality system including a waveguide display for exit pupil expansion according to certain embodiments.

FIG. 6A illustrates an example of a waveguide display including grating couplers.

FIG. 6B illustrates an example of a grating-based waveguide display including multiple grating layers for different fields of view.

FIG. 7A is a top view of an example of a grating-based waveguide display with exit pupil expansion and dispersion reduction.

FIG. 7B is a side view of the example of the waveguide display of FIG. 7A.

FIG. 8A illustrates an example of a layer stack formed by bonding two substrates using a bonding layer.

FIG. 8B illustrates another example of a waveguide display.

FIG. 8C illustrates an example of a multi-layer waveguide display.

FIG. 9A illustrates an example of a process for bonding two optical substrates using a liquid optically clear adhesive (LOCA) layer.

FIG. 9B illustrates an example of the polymerization of a LOCA material upon UV curing.

FIG. 10A illustrates an example of a waveguide display including a waveguide layer having a wedge shape.

FIG. 10B illustrates an example of a layer stack formed by bonding two flat substrates using a liquid optically clear adhesive.

FIG. 11A illustrates an example of a process for bonding two optical substrates using a LOCA layer according to certain embodiments.

FIG. 11B illustrates an example of the polymerization of a LOCA material including a reactive plasticizer upon UV curing.

FIG. 12A shows substrate bowing of examples of substrate stacks bonded using LOCAs that are cured by different curing processes.

FIG. 12B shows substrate bowing of examples of substrate stacks bonded using LOCAs that are cured by different curing processes.

FIG. 12C shows substrate bowing of examples of substrates with LOCA coatings that are cured by different curing processes.

FIG. 12D shows substrate bowing of examples of substrates with LOCA coatings that include a reactive plasticizer according to certain embodiments.

FIG. 12E shows substrate bowing of examples of substrate stacks bonded using LOCAs that include a reactive plasticizer according to certain embodiments.

FIG. 12F shows substrate bowing of examples of substrate stacks bonded using LOCAs that include a reactive plasticizer according to certain embodiments.

FIG. 13A includes a flowchart illustrating an example of a process of bonding optical substrates that are transparent to visible light according to certain embodiments.

FIG. 13B includes a flowchart illustrating another example of a process of bonding optical substrates that are transparent to visible light according to certain embodiments.

FIG. 14 is a simplified block diagram of an electronic system of an example of a near-eye display for implementing some of the examples disclosed herein.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

This disclosure relates generally to techniques for bonding optical components. More specifically, disclosed herein are techniques for bonding optical substrates (with or without optical components formed thereon) using liquid optically clear adhesives (LOCAs) to achieve a controlled thickness and a low bowing in the bonded devices. Various inventive embodiments are described herein, including devices, systems, methods, processes, materials, mixtures, compositions, and the like.

In waveguide-based near-eye display systems, light of projected images may be coupled into a waveguide (e.g., a substrate) using an input coupler (e.g., a grating coupler formed on the waveguide), propagate within the waveguide through total internal reflections, and be coupled out of the waveguide at different locations using an output coupler (e.g., a grating coupler) to replicate exit pupils and expand the eyebox. Two or more gratings may be used to expand the eyebox in two dimensions. Light from the surrounding environment may pass through at least a see-through region of the waveguide and reach the user's eyes. In some waveguide-based near-eye display systems, optical components (e.g., substrates with optical elements formed thereon, such as light sources, gratings, micro-lenses, or liquid crystal structures) may be bonded together to form a waveguide display. For example, some input/output couplers implemented using diffractive optical elements (e.g., volume Bragg gratings or polarization volume gratings) may only diffract light within a narrow wavelength range (e.g., light of a certain color) and/or a small field of view (e.g., light within a certain incident angle range), and may have limited coupling efficiencies. Therefore, in some waveguide display systems, multiple grating couplers (e.g., for diffracting light of different colors and light from different fields of view) may be formed in multiple grating layers on multiple substrates, and then the multiple substrates including the multiple grating couplers may be bonded together to form a waveguide that includes the multiple grating couplers.

In some reflective/refractive/polarization optical element-based near-eye display systems, such as some folded optics (e.g., pancake lenses) or freeform optics based AR/VR systems, multi-layer waveguides, flat substrates, partial reflective mirrors, freeform lenses, waveplates, liquid crystal devices, and/or other components may need to be bonded or otherwise integrated to form the near-eye display systems, where the thickness and the bowing of the bonded devices may need to be precisely controlled to achieve the desired system performance.

In some display panels (e.g., liquid crystal displays (LCDs), light emitting diode (LED) displays, organic light emitting diode (OLED) displays, or flexible displays), optical substrates with or without other structures formed thereon (e.g., backlights, touch panels with capacitive touch sensors, transparent conductive oxide layers, polarizers, diffusers, antireflection coating, micro-lenses for light collimation, and protective covers) may also need to be bonded to form the display panels.

Bonding two optical substrates (e.g., including one or more optical waveguide layers or other substrates) may be accomplished by using a liquid optically clear adhesive (LOCA). In general, a LOCA coating may be applied onto at least a first substrate, a second substrate may be placed above the LOCA coating, the substrate stack may undergo thermal drying of solvent, any partial cure or catalyst activation (e.g., UV activation), and/or compression bonding, and then the LOCA coating may be cured via UV curing, thermal curing, or a combination. Any or all of the curing steps may be carried out under compression. The curing process may transform the LOCA from its initial liquid state into an intermediate thermoplastic state, and then into a final thermoset state, where the adhesion strength of the bonded stack may be maximized and the LOCA mechanical properties may be stable against further thermal processing. At a molecular level, the curing process may lead to polymerization and crosslinking of the LOCA. In order for the LOCA to be compatible with the optical substrates for waveguide display applications, the LOCA needs to be transparent to visible light (e.g., with an absorption less than about 0.1%/μm), have a high refractive index (e.g., greater than about 1.6 at 450 nm), and can fully crosslink via curing, without inducing a large internal stress. The high transparency and high refractive index can be achieved by utilizing, for example, siloxane-containing epoxy-based LOCAs. These materials can have refractive indices about 1.6 or higher at 450 nm, their absorption can be below about 0.1%/μm of the LOCA materials, and their adhesion strength to glass may typically be above 1.5 Mpa. Therefore, these LOCA materials can be used to form permanent bonds between two optical substrates, and the bonds may be able to survive device processing and reliability testing.

To achieve a desired performance, the thickness variation and bowing of the bonded substrate stack may need to be precisely controlled. For example, the two opposing external surfaces of a substrate stack including two flat substrates bonded together may need to maintain a high degree of parallelism, and the substrate stack may need to have a minimal total thickness variation (TTV) and bowing (e.g., with a very small wedge angle). Existing bonding processes and materials may not be able to achieve a TTV and/or a bowing that are sufficiently low for some applications, such as high end AV/VR applications. For example, the crosslinking process of siloxane epoxy-based LOCAs with high transparency and high refractive index may typically lead to significant shrinkage that may build up internal stress within the LOCA layer. The build-up of the internal stress may lead to deformation (e.g., bowing) of the bonded substrate stack or even delamination, during normal processing and/or reliability testing, if the internal stress is too high. In cases where thermal curing of the LOCA may be performed and the two optical substrates may have different thermal expansion coefficients (CTEs), the bonded substrate stack may experience further deformation due to the CTE mismatch and the heating/cooling of the bonded substrate stack, which may increase the bowing of the bonded substrate stack and even result in permeant deformation of the bonded substrate stack. When at least one of the bonded optical substrates is used as an optical waveguide, the deformation of the substrate stack due to the LOCA internal stress may lead to aberrations and other optical artifacts, such as chief ray angle shift, modulation transfer function degradation, lateral color aberration, pupil swim, text breaks, and double images, thereby degrading the optical performance of the waveguide display. When 6-inch wafers are used as the substrates and the bowing of the bonded substrate stack is greater than about 20 μm, the optical performance of the waveguide display may not be acceptable. Thus, it is desirable that the LOCA materials utilized in the process of bonding two optical substrates for waveguide display (e.g., siloxane epoxy-based LOCA with high refractive index and low optical absorption) do not build significant internal stress that may deform the bonded substrate stack via bowing, during the curing and crosslinking and upon thermal treatment.

According to certain embodiments, two optical substrates, where at least one of them may be used as an optical waveguide layer, can be bonded using a siloxane epoxy-based LOCA that also includes a reactive plasticizer, such as a siloxane additive of Structure 1:

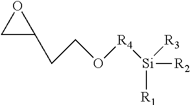

where R₁, R₂, and R₃ may include methoxide, ethoxide, propoxide, or a mixture of these materials, and R₄ may be an alkyl chain that is linear or branched and is composed of 2-8 carbons, such as linear C₆H₁₂. R₁, R₂, and R₃ may improve the adhesion strength of the LOCA, whereas R₄ may help to reduce stress of the LOCA during the curing and thermal treatment. Thus, the siloxane additive of Structure 1 may allow the LOCA to have reduced internal stress, such that the bowing of the bonded substrate stack may be minimized and the optical performance of the waveguide display may not be compromised. For example, when the optical substrates include 6-inch wafers, the bow of the bonded substrate stack may be below about 20 μm, and the performance of the waveguide display may not be degraded or may only be minimally degraded. Upon curing, the mixture of the LOCA and the siloxane additive of Structure 1 may result in a permanently bonded layer with stable mechanical properties, a refractive index about 1.6 or higher at 450 nm, an absorption below about 0.1%/μm, and an adhesion strength to glass greater than about 1.5 MPa.

According to certain embodiments, an optically clear, siloxane-containing epoxy adhesive mixture for bonding two optical substrates may be cured via UV, thermal, or both UV and thermal processes to produce a high refractive index, high transparency, and low bowing bonding layer that can provide high adhesion for the bonded substrate stack. The adhesive mixture may include, for example, siloxane and epoxy-containing oligomers, a UV-activated photo-acid generator, a crosslinker additive, a solvent, and an additive of Structure 1, where the additive of Structure 1 may constitute about 1-7% of the total mass of the adhesive mixture (excluding the solvent). In the additive of Structure 1, R₁, R₂, and R₃ may include methoxide, ethoxide, propoxide, or a mixture of these materials, and R₄ may include an alkyl chain that is linear or branched and includes 2-8 carbons. The adhesive mixture, when cured, may have a refractive index between about 1.6 and about 1.7 at 450 nm, and an optical absorption below 0.1% per micrometer of the adhesive mixture. The adhesive mixture, when applied onto 4-8 inch wafers and cured, may yield a bonded wafer stack with a bow below about 20 micrometers.

According to certain embodiments, a method of bonding two optical substrates may include spin-coating, spraying, ink-jet printing, screen-printing, needle dispensing, or otherwise dispensing an adhesive layer including a siloxane-containing epoxy adhesive mixture onto a first substrate, and bonding the adhesive layer to a second substrate by curing the adhesive mixture via a combination of UV curing and thermal curing. The adhesive mixture may include an additive of Structure 1, where the additive of Structure 1 may constitute about 1-7% of the total mass of the mixture (excluding the solvent). The adhesive mixture may be applied onto the first substrate to form an adhesive layer with a thickness about 1-100 microns. The adhesive mixture may be cured to generate a mechanically stable adhesive layer with a refractive index between about 1.6 and about 1.7 at 450 nm, and an optical absorption below about 0.1% per micrometer of the adhesive mixture. The bonded substrate stack may have a lap shear strength of at least 2.0 MPa, and a low degree of bowing. In some embodiments, the first substrate and the second substrate may be transparent substrates with diameters about 4 to 8 inches, and the bonded substrate stack may have a bow below 20 micrometers. In some embodiments, at least one of the first substrate or the second substrate may be a lens with an arbitrary shape and a length about 1 to 4 inches, and the bow of the bonded substrate stack may be below about 10 micrometers.

According to certain embodiments, two transparent substrates may be bonded together by a siloxane-containing epoxy adhesive layer created from a mixture including an additive of Structure 1, where the additive of Structure 1 may constitute about 1-7% of the total mass of the mixture excluding the solvent. The adhesive layer may be mechanically stable, and may have a refractive index between about 1.6 and about 1.7 at 450 nm and an optical absorption below about 0.1% per micrometer of the adhesive layer. The substrate stack bonded by the adhesive layer may have a lap shear strength of at least 2.0 MPa, and may have a low degree of bowing. In one example, the two transparent substrates may be wafers with diameters about 4 to 8 inches, and the bonded substrate stack may have a bow below 20 micrometers. In some embodiments, at least one of the two transparent substrates is a lens having an arbitrary shape and a length about 1 to 4 inches, and the bow of the bonded substrate stack is below 10 micrometers.

Unless defined otherwise, all technical and scientific terms used herein have the same meaning as is commonly understood by one of ordinary skill in the art to which this disclosure belongs.

As used herein, the term “about” means that dimensions, sizes, formulations, parameters, shapes and other quantities and characteristics are not and need not be exact, but may be approximate and/or larger or smaller, as desired, reflecting tolerances, conversion factors, rounding off, measurement error and the like, and other factors known to those of skill in the art. In general, a dimension, size, formulation, parameter, shape or other quantity or characteristic is “about” or “approximate” whether or not expressly stated to be such. It is noted that embodiments of different sizes, shapes and dimensions may employ the described arrangements.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

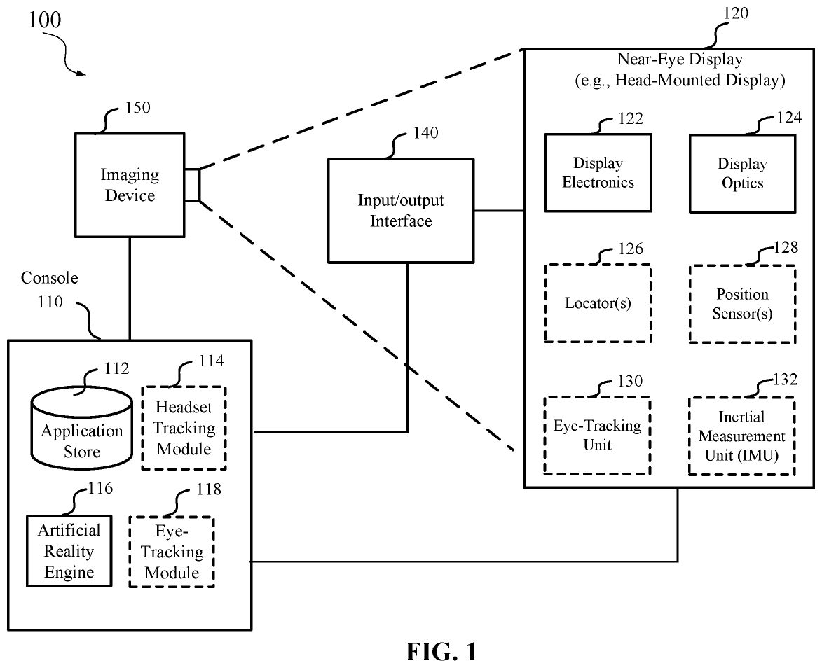

FIG. 1 is a simplified block diagram of an example of an artificial reality system environment 100 including a near-eye display 120 in accordance with certain embodiments. Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

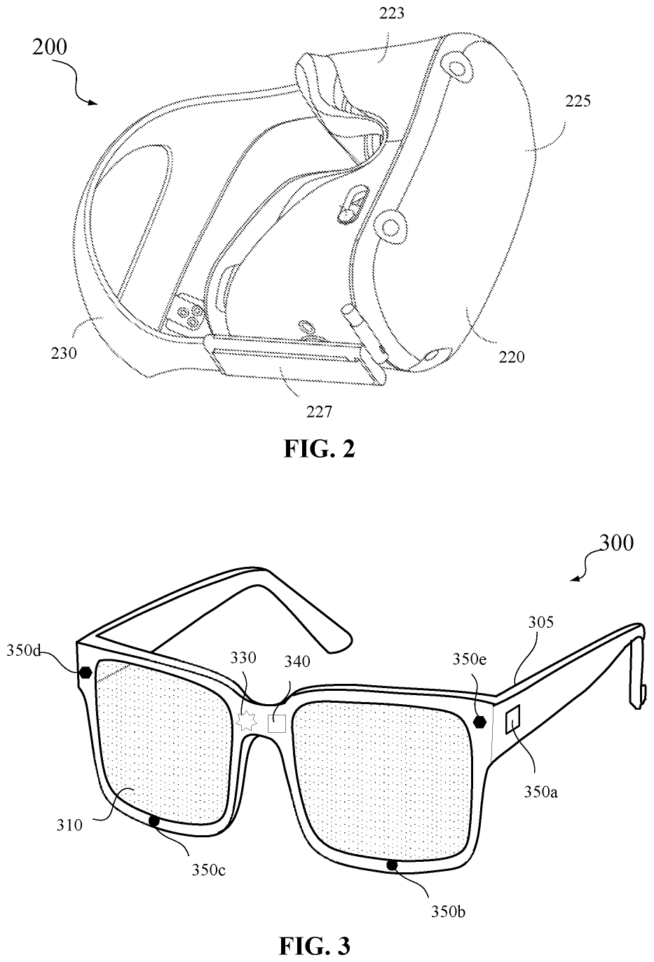

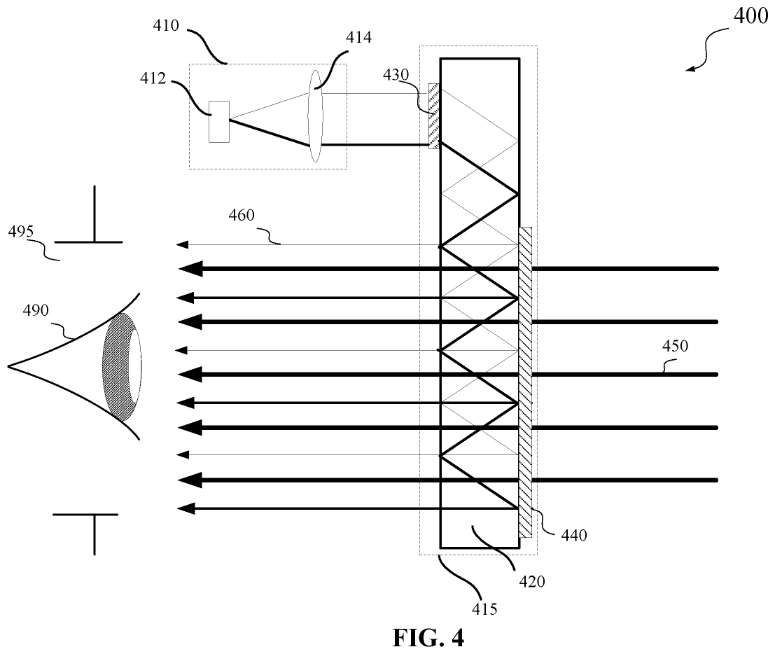

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an antireflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display 120.

Display optics 124 may also be designed to correct one or more types of optical errors, such as two-dimensional optical errors, three-dimensional optical errors, or any combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be a light-emitting diode (LED), a corner cube reflector, a reflective marker, a type of light source that contrasts with an environment in which near-eye display 120 operates, or any combination thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 10 nm to about 380 nm), in another portion of the electromagnetic spectrum, or in any combination of portions of the electromagnetic spectrum.

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120. For example, IMU 132 may integrate measurement signals received from accelerometers over time to estimate a velocity vector and integrate the velocity vector over time to determine an estimated position of a reference point on near-eye display 120. Alternatively, IMU 132 may provide the sampled measurement signals to console 110, which may determine the fast calibration data. While the reference point may generally be defined as a point in space, in various embodiments, the reference point may also be defined as a point within near-eye display 120 (e.g., a center of IMU 132).

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. For example, eye-tracking unit 130 may include a non-coherent or coherent light source (e.g., a laser diode) emitting light in the visible spectrum or infrared spectrum, and a camera capturing the light reflected by the user's eye. As another example, eye-tracking unit 130 may capture reflected radio waves emitted by a miniature radar unit. Eye-tracking unit 130 may use low-power light emitters that emit light at frequencies and intensities that would not injure the eye or cause physical discomfort. Eye-tracking unit 130 may be arranged to increase contrast in images of an eye captured by eye-tracking unit 130 while reducing the overall power consumed by eye-tracking unit 130 (e.g., reducing power consumed by a light emitter and an imaging system included in eye-tracking unit 130). For example, in some implementations, eye-tracking unit 130 may consume less than 100 milliwatts of power.

Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or any combination thereof. Because the orientation may be determined for both eyes of the user, eye-tracking unit 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface may provide haptic feedback when an action request is received, or when console 110 has performed a requested action and communicates instructions to input/output interface 140. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking module 114, an artificial reality engine 116, and an eye-tracking module 118. Some embodiments of console 110 may include different or additional modules than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the modules of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking module 114 may track movements of near-eye display 120 using slow calibration information from external imaging device 150. For example, headset tracking module 114 may determine positions of a reference point of near-eye display 120 using observed locators from the slow calibration information and a model of near-eye display 120. Headset tracking module 114 may also determine positions of a reference point of near-eye display 120 using position information from the fast calibration information. Additionally, in some embodiments, headset tracking module 114 may use portions of the fast calibration information, the slow calibration information, or any combination thereof, to predict a future location of near-eye display 120. Headset tracking module 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking module 114. Artificial reality engine 116 may also receive estimated eye position and orientation information from eye-tracking module 118. Based on the received information, artificial reality engine 116 may determine content to provide to near-eye display 120 for presentation to the user. For example, if the received information indicates that the user has looked to the left, artificial reality engine 116 may generate content for near-eye display 120 that mirrors the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking module 118 may receive eye-tracking data from eye-tracking unit 130 and determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking module 118 to more accurately determine the eye's orientation.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a μLED display, an AMOLED, a TOLED, some other display, or any combination thereof. HMD device 200 may include two eye box regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. High-resolution camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

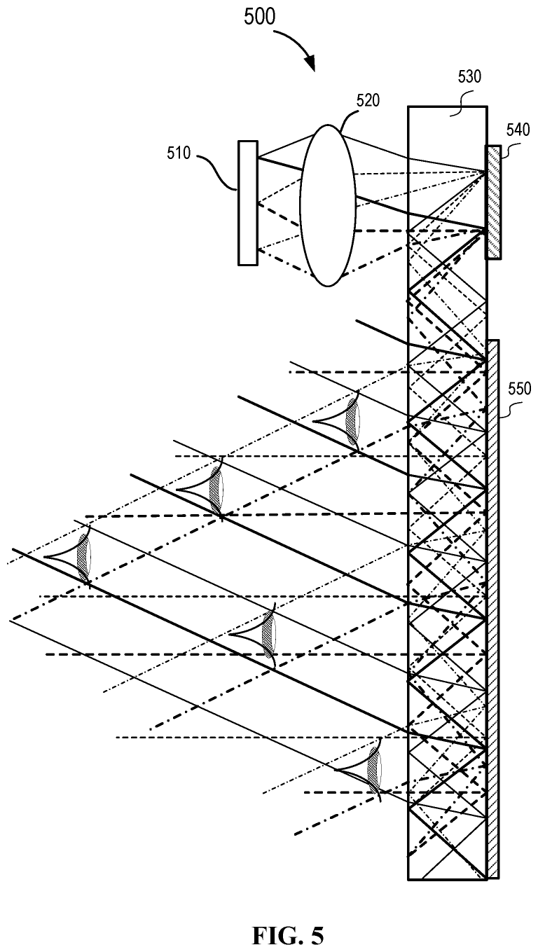

FIG. 4 illustrates an example of an optical see-through augmented reality system 400 including a waveguide display according to certain embodiments. Augmented reality system 400 may include a projector 410 and a combiner 415. Projector 410 may include a light source or image source 412 and projector optics 414. In some embodiments, light source or image source 412 may include one or more micro-LED devices described above. In some embodiments, image source 412 may include a plurality of pixels that displays virtual objects, such as an LCD display panel or an LED display panel. In some embodiments, image source 412 may include a light source that generates coherent or partially coherent light. For example, image source 412 may include a laser diode, a vertical cavity surface emitting laser, an LED, and/or a micro-LED described above. In some embodiments, image source 412 may include a plurality of light sources (e.g., an array of micro-LEDs described above), each emitting a monochromatic image light corresponding to a primary color (e.g., red, green, or blue). In some embodiments, image source 412 may include three two-dimensional arrays of micro-LEDs, where each two-dimensional array of micro-LEDs may include micro-LEDs configured to emit light of a primary color (e.g., red, green, or blue). In some embodiments, image source 412 may include an optical pattern generator, such as a spatial light modulator. Projector optics 414 may include one or more optical components that can condition the light from image source 412, such as expanding, collimating, scanning, or projecting light from image source 412 to combiner 415. The one or more optical components may include, for example, one or more lenses, liquid lenses, mirrors, apertures, and/or gratings. For example, in some embodiments, image source 412 may include one or more one-dimensional arrays or elongated two-dimensional arrays of micro-LEDs, and projector optics 414 may include one or more one-dimensional scanners (e.g., micro-mirrors or prisms) configured to scan the one-dimensional arrays or elongated two-dimensional arrays of micro-LEDs to generate image frames. In some embodiments, projector optics 414 may include a liquid lens (e.g., a liquid crystal lens) with a plurality of electrodes that allows scanning of the light from image source 412.

Combiner 415 may include an input coupler 430 for coupling light from projector 410 into a substrate 420 of combiner 415. Input coupler 430 may include a volume Bragg grating (VBG), a diffractive optical element (DOE) (e.g., a surface-relief grating (SRG)), a slanted surface of substrate 420, or a refractive coupler (e.g., a wedge or a prism). For example, input coupler 430 may include a reflective volume Bragg grating or a transmissive volume Bragg grating. Input coupler 430 may have a coupling efficiency of greater than 30%, 50%, 75%, 90%, or higher for visible light. Light coupled into substrate 420 may propagate within substrate 420 through, for example, total internal reflection (TIR). Substrate 420 may be in the form of a lens of a pair of eyeglasses. Substrate 420 may have a flat or a curved surface, and may include one or more types of dielectric materials, such as glass, quartz, plastic, polymer, poly(methyl methacrylate) (PMMA), crystal, or ceramic. A thickness of the substrate may range from, for example, less than about 1 mm to about 10 mm or more. Substrate 420 may be transparent to visible light.

Substrate 420 may include or may be coupled to a plurality of output couplers 440, each configured to extract at least a portion of the light guided by and propagating within substrate 420 from substrate 420, and direct extracted light 460 to an eyebox 495 where an eye 490 of the user of augmented reality system 400 may be located when augmented reality system is in use. The plurality of output couplers 440 may replicate the exit pupil to increase the size of eyebox 495 such that the displayed image is visible in a larger area. As input coupler 430, output couplers 440 may include grating couplers (e.g., volume holographic gratings or surface-relief gratings), other diffraction optical elements, prisms, etc. For example, output couplers 440 may include reflective volume Bragg gratings or transmissive volume Bragg gratings. Output couplers 440 may have different coupling (e.g., diffraction) efficiencies at different locations. Substrate 420 may also allow light 450 from the environment in front of combiner 415 to pass through with little or no loss. Output couplers 440 may also allow light 450 to pass through with little loss. For example, in some implementations, output couplers 440 may have a very low diffraction efficiency for light 450 such that light 450 may be refracted or otherwise pass through output couplers 440 with little loss, and thus may have a higher intensity than extracted light 460. In some implementations, output couplers 440 may have a high diffraction efficiency for light 450 and may diffract light 450 in certain desired directions (i.e., diffraction angles) with little loss. As a result, the user may be able to view combined images of the environment in front of combiner 415 and images of virtual objects projected by projector 410.

In some embodiments, projector 410, input coupler 430, and output coupler 440 may be on any side of substrate 420. Input coupler 430 and output coupler 440 may be reflective gratings (also referred to as reflective gratings) or transmissive gratings (also referred to as transmissive gratings) to couple display light into or out of substrate 420.

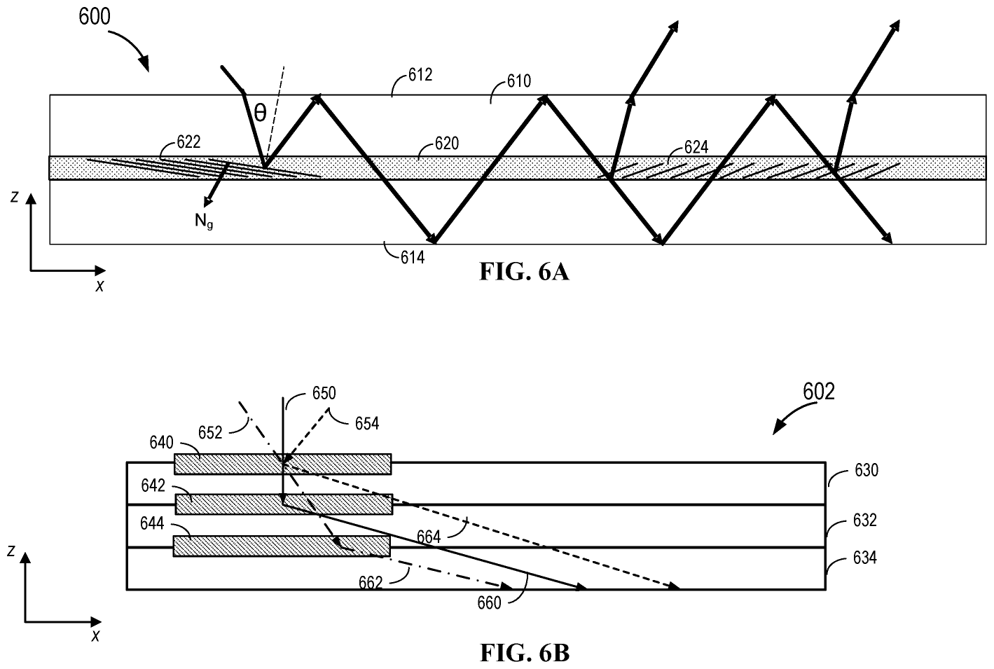

FIG. 5 illustrates an example of an optical see-through augmented reality system 500 including a waveguide display for exit pupil expansion according to certain embodiments. Augmented reality system 500 may be similar to augmented reality system 500, and may include the waveguide display and a projector that may include a light source or image source 510 and projector optics 520. The waveguide display may include a substrate 530, an input coupler 540, and a plurality of output couplers 550 as described above with respect to augmented reality system 500. While FIG. 5 only shows the propagation of light from a single field of view, FIG. 5 shows the propagation of light from multiple fields of view.

FIG. 5 shows that the exit pupil is replicated by output couplers 550 to form an aggregated exit pupil or eyebox, where different regions in a field of view (e.g., different pixels on image source 510) may be associated with different respective propagation directions towards the eyebox, and light from a same field of view (e.g., a same pixel on image source 510) may have a same propagation direction for the different individual exit pupils. Thus, a single image of image source 510 may be formed by the user's eye located anywhere in the eyebox, where light from different individual exit pupils and propagating in the same direction may be from a same pixel on image source 510 and may be focused onto a same location on the retina of the user's eye. FIG. 5 shows that the image of the image source is visible by the user's eye even if the user's eye moves to different locations in the eyebox.

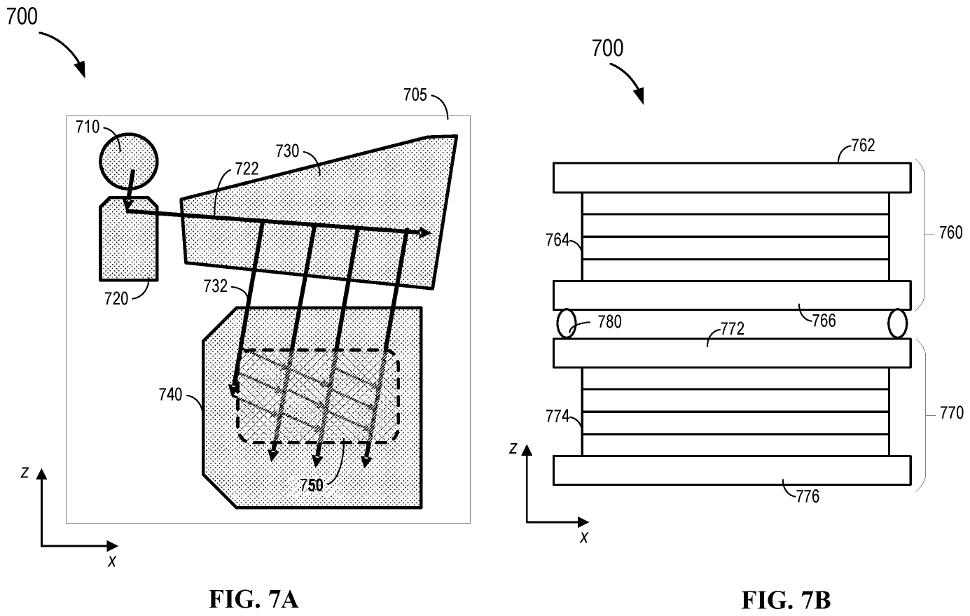

FIG. 6A illustrates an example of a waveguide display 600 including volume Bragg grating couplers. Waveguide display 600 may include a VBG layer 620 within a substrate 610 or between two substrate that are bonded together. For example, VBG layer 620 may be formed on one substrate and the substrate with VBG layer 620 may be bonded to another substrate, such that VBG layer 620 may be sandwiched by the two substrates to form a waveguide display, where display light may be reflected by a top surface 612 and a bottom surface 614. VBG layer 620 may include an input VBG 622 and an output VBG 624. In the illustrated example, input VBG 622 may reflectively diffract incident light, and thus may function as a reflective VBG. Output VBG 624 may partially reflectively diffract the light from input VBG 622 out of substrate 610 towards an eyebox of waveguide display 600. Input VBG 622 and output VBG 624 may function as multiple reflectors that strongly reflect light of a specific wavelength and/or from a specific angle that satisfies the Bragg condition. In various embodiments, depending on the slant angle of the multiple reflectors in the VBG, input VBG 622 and output VBG 624 may be transmissive VBGs or reflective VBGs, where the reflected light may or may not pass through the VBG such that the VBG may transmissively or reflectively diffract the incident light. The reflectivity of each of the multiple reflectors may depend on the polarization state, the wavelength, and the incident angle of the incident light, and the period, the base refractive index, and the refractive index modulation (Δn) of the VBG.

FIG. 6B illustrates an example of a grating-based waveguide display 602 including multiple grating layers for different fields of view according to certain embodiments. In waveguide display 602, gratings may be spatially multiplexed along the z direction. For example, waveguide display 602 may include multiple substrates, such as substrates 630, 632, 634, and the like. The substrates may include a same material or materials having similar refractive indexes. One or more gratings 640, 642, 644, and the like (e.g., VBGs or SRGs) may be made on each substrate, such as recorded in a holographic material layer formed on the substrate or etched in the substrate. The gratings may be reflective gratings or transmissive gratings. The substrates with the gratings may be arranged in a substrate stack along the z direction for spatial multiplexing. In some embodiments, each grating 640, 642, or 644 may be a multiplexed VBG that includes multiple gratings designed for different Bragg conditions to couple display light in different wavelength ranges and/or different FOVs into or out of waveguide display 602. In the example shown in FIG. 6B, grating 640 may couple light 654 from a positive field of view into the waveguide as shown by a light ray 664 within the waveguide. Grating 642 may couple light 650 from around 0° field of view into the waveguide as shown by a light ray 660 within the waveguide. Grating 644 may couple light 652 from a negative field of view into the waveguide as shown by a light ray 662 within the waveguide.

In many waveguide-based near-eye display systems, in order to expand the eyebox of the waveguide-based near-eye display in two dimensions, two or more output gratings may be used to expand the display light in two dimensions or along two axes (which may be referred to as dual-axis pupil expansion). The two gratings may have different grating parameters, such that one grating may be used to replicate the exit pupil in one direction and the other grating may be used to replicate the exit pupil in another direction.

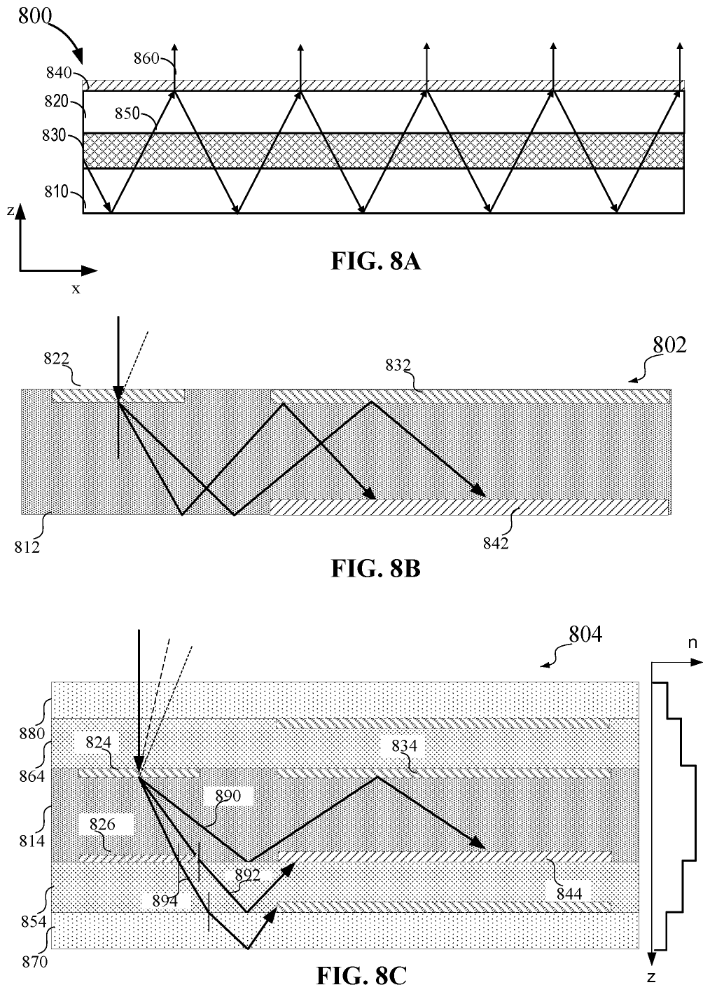

FIG. 7A is a top view of an example of a grating-based (e.g., volume Bragg grating or surface-relief grating -based) waveguide display 700 with exit pupil expansion and dispersion reduction according to certain embodiments. Waveguide display 700 may be an example of augmented reality system 400 or 500, and may include a waveguide 705, an input grating 710, a first middle grating 720, a second middle grating 730, and an output grating 740 formed on or in waveguide 705. Each of input grating 710, first middle grating 720, second middle grating 730, and output grating 740 may be a transmissive grating or a reflective grating. Display light from a light source (e.g., one or more micro-LED arrays) may be coupled into waveguide 705 by input grating 710. The in-coupled display light may be reflected by surfaces of waveguide 705 through total internal reflection as shown in FIG. 4, such that the display light may propagate within waveguide 705. Input grating 710 may include VBGs or SRGS. In one example, input grating 710 may include multiplexed VBGs and may couple display light of different colors and from different fields of view into waveguide 705 at corresponding diffraction angles.

First middle grating 720 and second middle grating 730 may be in different regions of a same holographic material layer or may be on different holographic material layers. In some embodiments, first middle grating 720 may be spatially separate from second middle grating 730. First middle grating 720 and second middle grating 730 may each include multiplexed VBGs or SRGs. In some embodiments, first middle grating 720 and second middle grating 730 may be recorded in a same number of exposures and under similar recording conditions, such that each VBG in first middle grating 720 may match a respective VBG in second middle grating 730 (e.g., having the same grating vector in the x-y plane and having the same and/or opposite grating vectors in the z direction). For example, in some embodiments, a VBG in first middle grating 720 and a corresponding VBG in second middle grating 730 may have the same grating period and the same grating slant angle (and thus the same grating vector), and the same thickness. In one example, first middle grating 720 and second middle grating 730 may have a thickness about 20 μm and may each include about 20 or more VBGs recorded through about 20 or more exposures.

Output grating 740 may be formed in the see-through region of waveguide display 700 and may include an exit region 750 that overlaps with the eyebox of waveguide display 700 when viewed in the z direction (e.g., at a distance about 18 mm from output grating 740 in +z or −z direction). Output grating 740 may include SRGs or multiplexed VBG gratings that include many VBGs. In some embodiments, output grating 740 and second middle grating 730 may at least partially overlap in the x-y plane, thereby reducing the form factor of waveguide display 700. Output grating 740, in combination with first middle grating 720 and second middle grating 730, may perform the dual-axis pupil expansion described above to expand the incident display light beam in two dimensions to fill the eyebox with the display light.

Input grating 710 may couple the display light from the light source into waveguide 705. The display light may reach first middle grating 720 directly or may be reflected by surfaces of waveguide 705 to first middle grating 720, where the size of the display light beam may be slightly larger than the size of the display light beam at input grating 710. Each VBG in first middle grating 720 may diffract a portion of the display light within a FOV range and a wavelength range that approximately satisfies the Bragg condition of the VBG to second middle grating 730. While the display light diffracted by a VBG in first middle grating 720 propagates within waveguide 705 (e.g., along a direction shown by a line 722) through total internal reflection, a portion of the display light may be diffracted by the corresponding VBG in second middle grating 730 towards output grating 740 each time the display light propagating within waveguide 705 reaches second middle grating 730, as shown by lines 732. Output grating 740 may then expand the display light from second middle grating 730 in a different direction by diffracting a portion of the display light to the eyebox each time the display light propagating within waveguide 705 reaches exit region 750 of output grating 740.

As described above, each VBG in first middle grating 720 may match a respective VBG in second middle grating 730 (e.g., having the same grating vector in the x-y plane and having the same and/or opposite grating vector in the z direction). The two matching VBGs may work under opposite Bragg conditions (e.g., +1 order diffraction versus −1 order diffraction) due to the opposite propagation directions of the display light at the two matching VBGs. For example, as shown in FIG. 7A, the VBG in first middle grating 720 may change the propagation direction of the display light from a downward direction to a rightward direction, while the matching VBG in second middle grating 730 may change the propagation direction of the display light from a rightward direction to a downward direction. Thus, the dispersion caused by second middle grating 730 may be opposite to the dispersion caused by first middle grating 720, thereby reducing or minimizing the overall dispersion.

Similarly, each VBG in input grating 710 may match a respective VBG in output grating 740 (e.g., having the same grating vector in the x-y plane and having the same and/or opposite grating vector in the z direction). The two matching VBGs may also work under opposite Bragg conditions (e.g., +1 order diffraction versus −1 order diffraction) due to the opposite propagation directions of the display light (e.g., into and out of waveguide 705) at the two matching VBGs. Therefore, the dispersion caused by input grating 710 may be opposite to the dispersion caused by output grating 740, thereby reducing or minimizing the overall dispersion.

FIG. 7B is a side view of the example of waveguide display 700 including grating couplers. As illustrated, waveguide display 700 may include a first assembly 760 and a second assembly 770 that may be separated by a spacer 780. First assembly 760 may include a first substrate 762, a second substrate 766, and one or more grating layers 764 between first substrate 762 and second substrate 766. First substrate 762 and second substrate 766 may each be a thin transparent substrate, such as a glass substrate having a thickness about 100 μm or few hundred micrometers. Grating layers 764 may include multiplexed reflective VBGs, transmissive VBGs, SRGs, or a combination. Similarly, second assembly 770 may include a first substrate 772, a second substrate 776, and one or more grating layers 774 between first substrate 772 and second substrate 776. Grating layers 774 may include multiplexed reflective VBGs, transmissive VBGs, SRGs, or a combination. In one example, first assembly 760 may be used to couple display light in red, green, and blue colors from certain fields of view to user's eyes, and second assembly 770 may be used to couple display light in red, green, and blue colors from other fields of view to user's eyes.

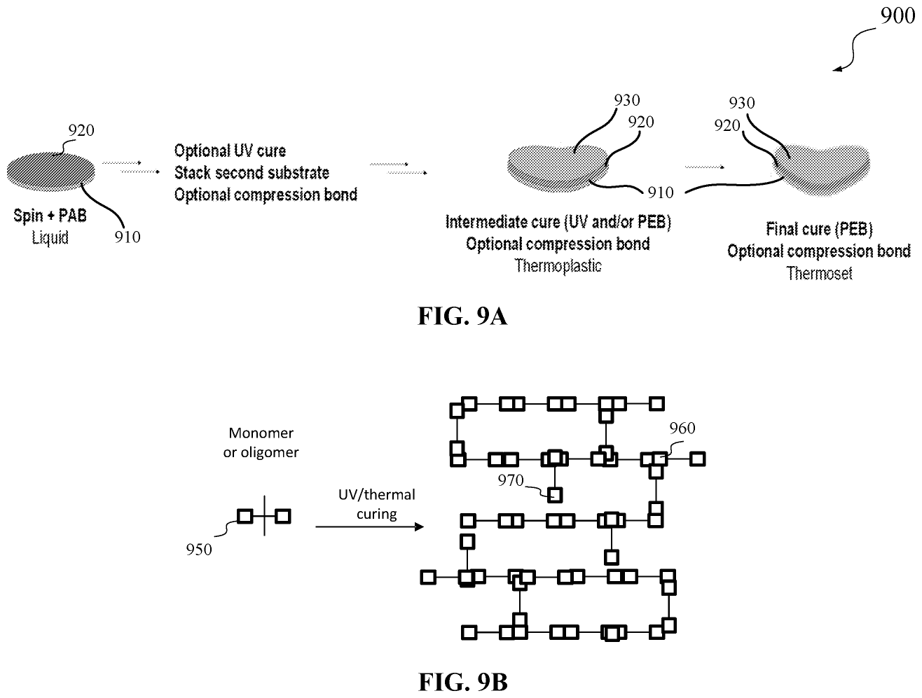

FIG. 8A illustrates an example of a layer stack 800 formed by bonding two substrates 810 and 820 using a bonding layer 830. Layer stack 800 may be used as a waveguide for guiding display light, and may include one or more optical elements formed on one or both substrates, as described above. In the illustrated example, an output grating coupler 840 may be formed on substrate 820. Substrate 810 may or may not include a grating formed thereon. A light beam 850 coupled into the waveguide may propagate within the waveguide through total internal reflection. Each time the guided light beam reaches output grating coupler 840, a portion 860 of the guided light beam may be coupled out of the waveguide by output grating coupler 840. In layer stack 800, the top surface of substrate 820 and the bottom surface of substrate 810 may be parallel to each other. Therefore, the incident angle of the guided light beam incident on the top surface of substrate 820 and the incident angle of the guided light beam incident on the bottom surface of substrate 810 may remain constant, and the portions 860 of the guided light beam coupled out of the waveguide at different locations may have the same diffraction angle.

FIG. 8B illustrates another example of a waveguide display 802. Waveguide display 802 may include a substrate 812, which may be similar to substrate 420 or 530. Substrate 812 may include, for example, glass, silicon, silicon nitride, silicon carbide, LiNbO₃, TiO₂, GaN, AlN, SiC, CVD diamond, ZnS, or any other suitable material. An input grating 822 and one or more output gratings 832 and 842 may be etched in substrate 812 or in a grating material layer formed on substrate 812. In some embodiments, input gratings 822 and output gratings 832 and 842 may be holographic gratings recorded in holographic material layers coated on substrate 812. In some embodiments, input grating 822 and output gratings 832 and 842 may include slanted or vertical surface-relief gratings etched in substrate 812 or imprinted in nanoimprint material layers deposited on substrate 812, and may include an overcoat layer filling the grating grooves. Output gratings 832 and 842 may be etched on opposite surfaces of substrate 812. In some embodiments, only one output grating 832 or 842 may be used. Input grating 822 may couple display light of different colors (e.g., red, green, and blue) from different view angles (or within different fields of view (FOVs)) into substrate 812, which may guide the in-coupled display light through total internal reflection. A portion of the in-coupled display light propagating within substrate 812 may be coupled out of substrate 812 towards an eyebox of waveguide display 802 by output grating 832 or 842 each time the in-coupled display light reaches output grating 832 or 842.

To satisfy the grating equation, a diffraction grating may diffract incident light of different colors (wavelengths) and/or from different view angles to different diffraction angles. For example, in the example illustrated in FIG. 8B, two light beams having different colors (e.g., red and blue) and the same incidence angle (e.g., about 0°) may be diffracted by input grating 822 to different directions within substrate 812. More specifically, the light beam having a shorter wavelength (e.g., blue light) may have a smaller diffraction angle. Two light beams having the same color but different incidence angles may also be diffracted by input grating 822 to two different directions within substrate 812. Due to the different propagation directions, the two in-coupled light beams may reach the surfaces of substrate 812 and be diffracted out of substrate 812 after propagating different distances in the x direction. A light beam having a smaller angle with respect to the surface-normal direction of substrate 812 may reach output grating 832 or 842 for a larger number of times than a light beam having a larger angle with respect to the surface-normal direction of substrate 812. In addition, a grating may not have a flat diffraction efficiency for incident light of different colors or different incidence angles. For at least these reasons, display light of different colors or from different FOVs may be directed to the eyebox at different densities, and may also form ghost images on the retina of user's eyes.

FIG. 8C illustrates an example of a multi-layer waveguide display 804 according to certain embodiments. Multi-layer waveguide display 804 may include a first waveguide layer 814 that includes one or more input gratings 824 and 826 and one or two output gratings 834 and 844 formed thereon as in waveguide display 802 described above. First waveguide layer 814 may include, for example, glass, silicon, silicon nitride, silicon carbide, LiNbO₃, TiO₂, GaN, AlN, CVD diamond, ZnS, and the like. Input gratings 824 and 826 and output gratings 834 and 844 may be slanted or vertical holographic or surface-relief gratings and may include an overcoat layer filling the grating grooves. In some embodiments, one or more of input gratings 824 and 826 and output gratings 834 and 844 may each have a variable grating period, a variable duty cycle, a variable slant angle, and/or a variable etch depth. In some embodiments, one or more of the input gratings and output gratings may each include a two-dimensional grating that has a variable grating period, a variable duty cycle, a variable slant angle, and/or a variable etch depth along two directions of the two-dimensional grating.

Multi-layer waveguide display 804 may include a second waveguide layer 854 and a third waveguide layer 864 on opposing sides of first waveguide layer 814. Second waveguide layer 854 and third waveguide layer 864 may each be a thin layer (e.g., a few hundred micrometers, such as between about 100 μm and about 600 μm) of a transparent material having a lower refractive index than the refractive index of first waveguide layer 814. For example, the difference between the refractive index of first waveguide layer 814 and the refractive index of second waveguide layer 854 or third waveguide layer 864 may be about 0.01, 0.02, 0.05, 0.1, 0.2, 0.25, 0.3, or larger. Second waveguide layer 854 and third waveguide layer 864 may have a same refractive index or different refractive indices.

In addition, a fourth waveguide layer 870 may be formed on second waveguide layer 354, and a fifth waveguide layer 880 may be formed on third waveguide layer 864. Fourth waveguide layer 870 and fifth waveguide layer 880 may each be a thin layer (e.g., a few hundred micrometers, such as between about 100 μm and about 600 μm) of a transparent material having a lower refractive index than the refractive indices of second waveguide layer 854 and third waveguide layer 864, respectively. For example, the difference between the refractive index of second waveguide layer 854 and the refractive index of fourth waveguide layer 870 and the difference between the refractive index of third waveguide layer 864 and the refractive index of fifth waveguide layer 880 may be about 0.01, 0.02, 0.05, 0.1, 0.2, 0.25, 0.3, or larger. Fourth waveguide layer 870 and fifth waveguide layer 880 may have a same refractive index or different refractive indices.

Multi-layer waveguide display 804 may achieve a more uniform replication of light having different colors and from different FOVs. For example, a first light beam 890 (e.g., having a longer wavelength or from a larger view angle) may be coupled into first waveguide layer 814 by input grating 824 and may propagate within first waveguide layer 814 with a large angle with respect to a surface-normal direction of first waveguide layer 814. Therefore, first light beam 890 may be reflected at the interface between first waveguide layer 814 and second waveguide layer 854 through total internal reflection, due to the large incidence angle and the large difference between the refractive indices of first waveguide layer 814 and second waveguide layer 854.

A second light beam 892 (e.g., having a shorter wavelength and/or from a smaller view angle) may be coupled into first waveguide layer 814 by input grating 824 and may propagate within first waveguide layer 814 with a smaller angle with respect to the surface-normal direction of first waveguide layer 814. Therefore, second light beam 892 may not be reflected at the interface between first waveguide layer 814 and second waveguide layer 854 through total internal reflection, because the incidence angle may be smaller than the critical angle at the interface. Thus, second light beam 892 may instead be refracted at the interface with a larger refraction angle into second waveguide layer 854, and may then be reflected at the bottom surface of second waveguide layer 854 through total internal reflection due to the increased incidence angle and the difference between the refractive indices of second waveguide layer 854 and fourth waveguide layer 870. Therefore, even though second light beam 892 may have a smaller propagation angle with respect to the surface-normal direction of first waveguide layer 814 than first light beam 890, second light beam 892 may travel a longer distance in the z direction before being reflected through total internal reflection, and thus may travel a similar distance in the x direction as first light beam 890 before being reflected through total internal reflection. In this way, first light beam 890 and second light beam 892 may be diffracted by output grating 834 or 844 at about the same locations (or same interval) and/or for about the same number of times.

Similarly, a third light beam 894 (e.g., having an even shorter wavelength and/or from an even smaller view angle) may be coupled into first waveguide layer 814 by input grating 824 and may propagate within first waveguide layer 814 with a smaller angle with respect to the surface-normal direction of first waveguide layer 814. Third light beam 894 may be refracted at the interface between first waveguide layer 814 and second waveguide layer 854 and the interface between second waveguide layer 854 and fourth waveguide layer 870, but may be reflected at the bottom surface of fourth waveguide layer 870 through total internal reflection due to the increased incidence angle and the difference between the refractive indices of fourth waveguide layer 870 and air. Therefore, even though third light beam 894 may have a small propagation angle with respect to the surface-normal direction of first waveguide layer 814 than first light beam 890, third light beam 894 may travel a longer distance in the z direction before being reflected through total internal reflection, and thus may travel a similar distance in the x direction as first light beam 890 before being reflected through total internal reflection. In this way, first light beam 890 and third light beam 894 may be diffracted by output grating 834 or 844 at about the same locations (or same interval) and/or for about the same number of times.

The thicknesses and the refractive indices of first waveguide layer 814, second waveguide layer 854, third waveguide layer 864, fourth waveguide layer 870, and fifth waveguide layer 880 may be selected based on the desired performance. In various embodiments, the multi-layer waveguide displays herein may include two or more waveguide layers, such as three, four, five, or more layers. In some embodiments, the low-index waveguide layers may be on a same side of the input and output gratings, and the refractive indices of the two or more waveguide layers may be the highest at one side of the layer stack and then gradually decrease towards the other side of the layer stack. In some embodiments, the low-index waveguide layers may be on opposing sides of the input and output gratings, and the refractive indices of the two or more waveguide layers may be the highest at the center of the layer stack and may gradually decrease towards two opposite sides of the layer stack. In some embodiments, the refractive index profile of the waveguide layer stack may be symmetrical and have the highest value at the center as shown in FIG. 8C. In some embodiments, the refractive index profile of the waveguide layer stack may not be symmetrical with respect to the center of the waveguide layer stack. In some embodiments, one or more gratings or other optical elements may be formed in or on waveguide layer 854, 864, 870, or 880.

In some embodiments, optical substrates (e.g., including one or more optical waveguide layers, such as waveguide layer 814, 854, 864, 870, or 880) may be bonded using a liquid optically clear adhesive (LOCA). In order for the LOCA to be compatible with the optical substrates for waveguide display applications, the LOCA needs to be transparent to visible light (e.g., with an absorption less than about 0.1%/μm), have a high refractive index (e.g., greater than about 1.6), and can fully crosslink via curing, without inducing a large internal stress. The high transparency and high refractive index can be achieved by utilizing, for example, siloxane-containing epoxy-based LOCAs. These materials can have refractive indices about 1.6 or higher at 450 nm, their absorption can be below about 0.1%/μm of the LOCA materials, and their adhesion strength to glass may typically be above 1.5 Mpa. Therefore, these LOCA materials can be used to form permanent bonds between two optical substrates, and the bonds may be able to survive device processing and reliability testing.

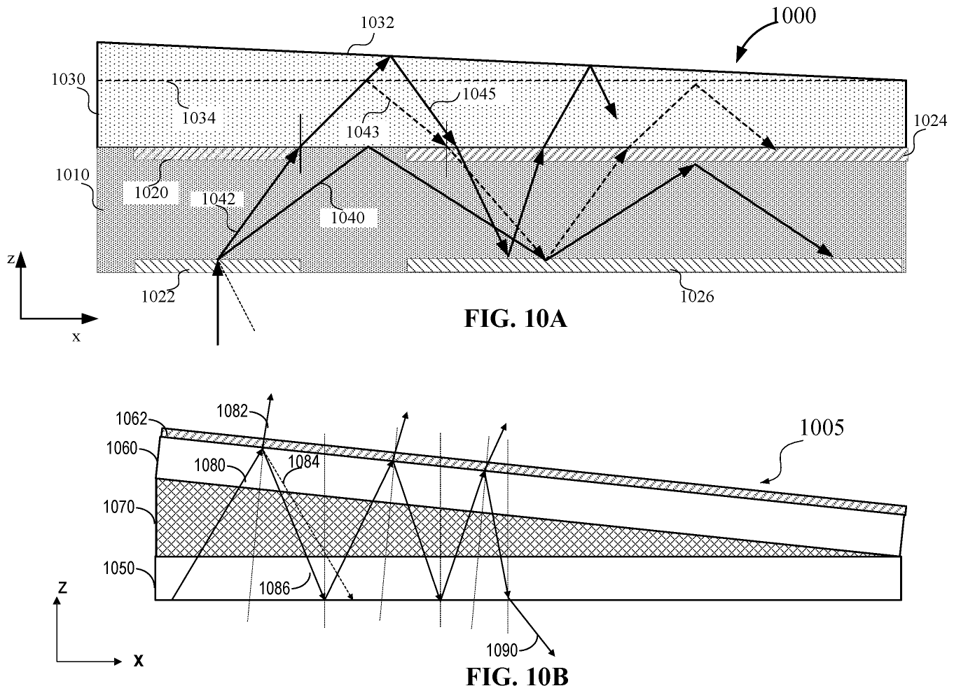

FIG. 9A illustrates an example of a process 900 for bonding two optical substrates using a LOCA layer. As illustrates, a LOCA layer 920 (e.g., including siloxane-containing epoxy-based LOCA) may be applied onto a first optical substrate 910 by, for example, spin-coating, spraying, ink-jet printing, screen-printing, or otherwise dispensing techniques. Any residual solvent may be evaporated thermally, for example, by post apply bake (PAB). The LOCA may be partially cured via UV treatment. A second optical substrate 930 may then be placed above LOCA layer 920 and first optical substrate 910, and the substrate stack may optionally undergo a compression bonding process by a compressor. The substrate stack including LOCA layer 920 between first optical substrate 910 and second optical substrate 930 may be cured via UV curing and/or thermal curing (e.g., post exposure bake (PEB)), which may transform the LOCA material from its initial liquid state into an intermediate thermoplastic state. The substrate stack may then be baked or otherwise thermally cured to transform the LOCA material from the thermoplastic state into a final thermoset state, where the adhesion strength of the bonded stack may be maximized and the LOCA mechanical properties may be stable against further thermal processing. Compression may be applied to the optical substrates in any or all of the curing steps.

FIG. 9B illustrates an example of the polymerization of a LOCA material upon UV curing. The LOCA material may include monomers or oligomers 950, such as siloxane and epoxy-containing oligomers, which may be small molecules. The LOCA material may also include a UV-activated photo-acid generator, a crosslinker additive, and a solvent. At a molecular level, the curing process may lead to polymerization and crosslinking of the LOCA material. More specifically, upon exposure to UV light, the UV-activated photo-acid generator may generate photo-acids, which may cause the crosslinking of oligomers 950. Any thermal treatment may then produce further cross-linking of the adhesive components. The crosslinked oligomers 950 may form polymers 960. Polymers 960 may include a long chain of oligomers or polymers and thus may have a large molecular weight. As the chains grow, the LOCA layer may shrink. As shown in FIG. 9B, polymers 960 may include some sites 970 that are not fully reacted. Therefore, polymers 960 may continue to grow at sites 970, which may crosslink the chains and build bridges between the chains. The crosslinking process of siloxane epoxy-based LOCAs may lead to significant shrinkage that may build up internal stress within the LOCA layer, because it is difficult for the large molecules to rearrange and relax as the LOCA layer shrinks or contracts. The build-up of the internal stress may lead to deformation (e.g., bowing) of the bonded substrate stack as shown in FIG. 9A. If the internal stress is too high, delamination may occur during normal processing and/or reliability testing.

During the thermal curing, the LOCA material may continue to polymerize and crosslink to form larger molecules with long chains of atoms, and thus LOCA layer 920 may continue to shrink during the thermal curing. For example, polymers 960 may continue to grow at sites 970, which may crosslink the chains and build bridges between the chains to form larger molecules, and thus may cause further shrinkage of the LOCA layer. The large molecules may need a large amount of energy to rearrange and relax while the LOCA layer shrinks or contracts. Thus, the internal stress may continue to build up as the LOCA layer continues to crosslink and shrink. The more crosslinks between the chains, the harder it is for the large molecules to rearrange and fully relax in order to reduce the internal stress while the LOCA layer shrinks. Therefore, the internal stress of the LOCA layer and the bowing of the bonded substrate stack may increase during the thermal curing as shown in FIG. 9A. In cases where the two optical substrates may have different thermal expansion coefficients (CTEs), the bonded substrate stack may experience further deformation during the thermal curing of the LOCA material, due to the CTE mismatch and the heating/cooling of the bonded substrate stack, which may increase the bowing of the bonded substrate stack and even result in permeant deformation of the bonded substrate stack.

When at least one of the bonded optical substrates is used as an optical waveguide, the deformation of the substrate stack due to LOCA internal stress may lead to aberrations and other optical artifacts, such as chief ray angle shift, modulation transfer function degradation, lateral color aberration, pupil swim, text breaks, and double images, thereby degrading the optical performance of the waveguide display. When 6-inch wafers are used as the substrates and the bowing of the bonded substrate stack is above 20 μm, the optical performance of the waveguide display may not be acceptable.

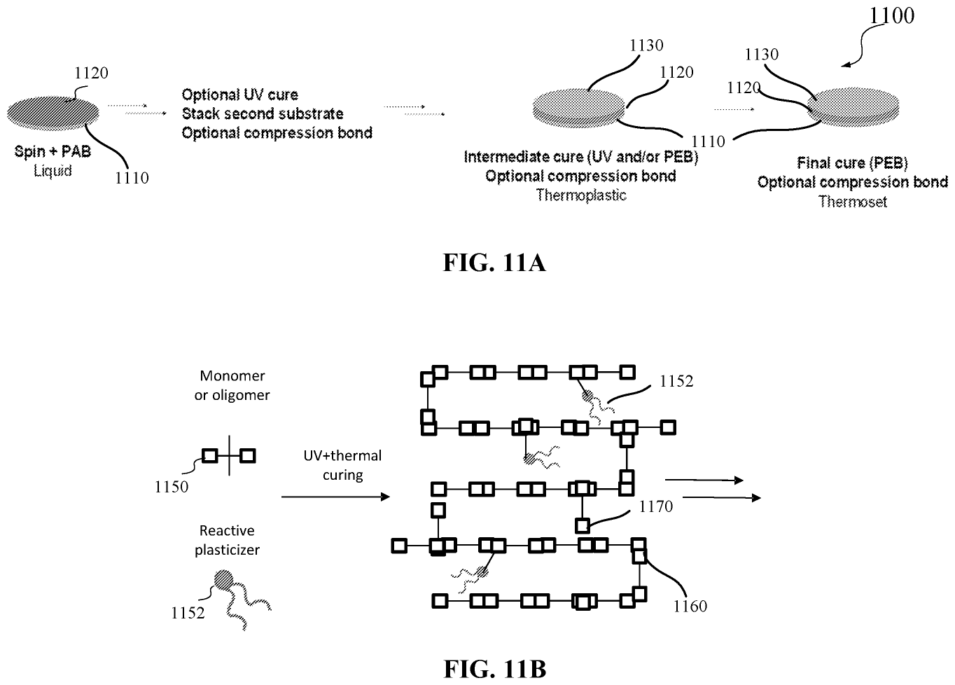

FIG. 10A illustrates an example of a waveguide display 1000 including a waveguide layer 1030 having a wedge shape due to, for example, substrate bowing caused by bonding waveguide layer 1030 to a waveguide layer 1010 using a LOCA material (not shown in FIG. 10A). Waveguide layer 1010 may include one or more input gratings 1020 and 1022, and one or more output gratings 1024 and 1026 to form waveguide display 1000. In the example shown in FIG. 10A, a first light beam 1040 (e.g., having a longer wavelength or from a larger view angle) may be coupled into waveguide layer 1010 by input grating 1022 at a large angle with respect to a surface-normal direction of waveguide layer 1010. Therefore, first light beam 1040 may be reflected at the interface between waveguide layer 1010 and waveguide layer 1030 through total internal reflection, due to the large incidence angle and the difference between the refractive indices of waveguide layer 1010 and waveguide layer 1030. A second light beam 1042 (e.g., having a shorter wavelength and/or from a smaller view angle) may be coupled into waveguide layer 1010 by input grating 1022 and may propagate within waveguide layer 1010 at a smaller angle with respect to the surface-normal direction of waveguide layer 1010. Therefore, second light beam 1042 may not be reflected at the interface between waveguide layer 1010 and waveguide layer 1030 through total internal reflection, because the incidence angle may be smaller than the critical angle at the interface. Thus, second light beam 1042 may instead be refracted at the interface with a larger refraction angle into waveguide layer 1030, and may then be reflected at the top surface of waveguide layer 1030 through total internal reflection due to the increased incidence angle and the larger difference (e.g., about 0.5) between the refractive indices of waveguide layer 1030 and air. When waveguide layer 1030 has a low (e.g., close to zero) TTV or a small wedge angle (e.g., having an ideal flat top surface as shown by a plane 1034), second light beam 1042 may be reflected at plane 1034 as shown by a light ray 1043. Even though second light beam 1042 may have a smaller propagation angle with respect to the surface-normal direction of waveguide layer 1010 than first light beam 1040, second light beam may travel a longer distance in the z direction before being reflected through total internal reflection, and thus may travel a similar distance in the x direction as first light beam 1040 before being reflected through total internal reflection (e.g., as shown by light ray 1043). In this way, first light beam 1040 and second light beam 1042 may be diffracted by output grating 1024 or 1026 at about the same locations (or about the same interval) and for about the same number of times. The thicknesses and refractive indices of waveguide layer 1010 and waveguide layer 1030 may be selected based on the desired performance.

However, due to substrate bowing caused by curing the LOCA bonding layer using UV light and/or heat, waveguide layer 1030 may have a wedge shape (e.g., having a wedge angle larger than 1 arcsec). Because of the wedge shape, the incident angle of second light beam 1042 (after being refracted into waveguide layer 1030) incident on a top surface 1032 of waveguide layer 1030 and the incident angle of the guided light beam incident on the bottom surface of waveguide layer 1010 may gradually change (e.g., gradually decrease in the illustrated example). For example, due to the unevenness of waveguide layer 1030, second light beam 1042 may instead be reflected by top surface 1032 of waveguide layer 1030 to a direction as shown by a light ray 1045. As such, first light beam 1040 and second light beam 1042 may be coupled out of waveguide display 1000 (e.g., diffracted by output grating 1024 or 1026) at different locations. In addition, the distance between two adjacent reflection locations at top surface 1032 may gradually decrease. As such, the exit pupil may not be evenly replicated.

Since the incident angles of the light beam incident on different locations of output gratings 1024 and 1026 may be different, the diffraction angles of the light beam diffracted at different locations of output gratings 1024 and 1026 may also be different. As such, display light from a same FOV angle may be diffracted at different locations of the output gratings towards l different directions. As a results, optical artifacts such as double images may occur and the quality of the displayed images may be poor. In some cases, since the incident angle of second light beam 1042 incident on top surface 1032 and the incident angle of second light beam 1042 incident on the bottom surface of waveguide layer 1010 may gradually decrease as second light beam 1042 propagates in waveguide display 1000, at some locations, the incident angle of second light beam 1042 incident on top surface 1032 or the incident angle of second light beam 1042 incident on the bottom surface of waveguide layer 1010 may be smaller than the critical angle, and thus may no longer be guided in waveguide display 1000 through total internal reflection.

FIG. 10B illustrates an example of a layer stack 1005 formed by bonding two flat substrates 1050 and 1060 using a liquid optically clear adhesive. In the illustrated example, an output grating coupler 1062 may be formed on substrate 1060. A LOCA layer 1070 may be dispensed between substrate 1050 and substrate 1060. Substrates 1050 and 1060 may be pushed together by applying a pressure (e.g., mechanical pressure or vacuum pressure) to the bottom surface of substrate 1050 and/or the top surface of substrate 1060. The LOCA material in LOCA layer 1070 may be allowed to flow without the pressure or in response to the pressure. After applying the pressure for a certain period of time, the LOCA material may be cured using, for example, UV light and/or heat (e.g., exposed to UV light in a chamber or baked in an oven) as described above.

Due to substrate bowing caused by curing LOCA layer 1070 using UV light and/or heat, layer stack 1005 may have a wedge shape. The angle of the wedge may not be precisely controlled, and may be large, such as larger than about 1×10⁻⁴ rad. A light beam 1080 coupled into a waveguide formed by the bonded layer stack 1005 may need to propagate within the waveguide through total internal reflection. Each time the guided light beam reaches output grating coupler 1062, a portion 1082 of the guided light beam may be coupled out of the waveguide by output grating coupler 1062. Since layer stack 1005 may have a wedge shape, the incident angle of the guided light beam incident on the top surface of substrate 1060 and the incident angle of the guided light beam incident on the bottom surface of substrate 1050 may gradually change (e.g., gradually decrease in the illustrated example). For example, if the top surface of substrate 1060 is parallel to the bottom surface of substrate 1050, the guided light beam may be reflected by the top surface of substrate 1060 (e.g., through TIR) to a direction as shown by a light ray 1084. Due to the wedge shape of layer stack 1005, the guided light beam may instead be reflected by the top surface of substrate 1060 to a direction as shown by a light ray 1086. As such, the directions of the portions 1082 of the guided light beam coupled out of the waveguide at different locations may be different as shown in FIG. 10B. In addition, the distance between two adjacent reflection locations at the top surface of substrate 1060 may gradually decrease. As such, the exit pupil may not be evenly replicated.

Moreover, since the incident angle of the guided light beam incident on the top surface of substrate 1060 and the incident angle of the guided light beam incident on the bottom surface of substrate 1050 may gradually decrease as the guided light beam propagates in the waveguide, at some locations, the incident angle of the guided light beam incident on the top surface of substrate 1060 or the incident angle of the guided light beam incident on the bottom surface of substrate 1050 may be smaller than the critical angle, and thus may no longer be guided in the waveguide through total internal reflection. Instead, as shown by a light ray 1090, the guided light beam may be refracted out of the waveguide.

Therefore, the variation of the thickness of the waveguide for waveguide display may lead to aberrations and other optical artifacts, such as chief ray angle shift, modulation transfer function degradation, lateral color aberration, pupil swim, text breaks, and double images, thereby degrading the optical performance of the waveguide display. To achieve a better optical performance, the waveguide including two or more waveguide layers bonded together may need to be flat, for example, having a low TTV and a low surface roughness. For example, the two opposing external surfaces of a substrate stack including two substrates bonded together may need to maintain a high degree of parallelism, and the substrate stack may need to have a minimal total thickness variation (TTV) and bowing (e.g., with a very small wedge angle). Thus, it is desirable that the LOCA materials utilized in the process of bonding two optical substrates for waveguide display (e.g., siloxane epoxy-based LOCA with high refractive index and low optical absorption) do not build significant internal stress that may deform the bonded substrate stack via bowing, during the curing and crosslinking and upon thermal treatment.

According to certain embodiments, two optical substrates, where at least one of them may be used as an optical waveguide layer, can be bonded using a siloxane epoxy-based LOCA that also includes a reactive plasticizer, such as a siloxane additive of Structure 1:

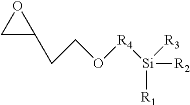

where R₁, R₂, and R₃ may include methoxide, ethoxide, propoxide, or a mixture of these materials, and R₄ may be an alkyl chain that is linear or branched and is composed of 2-8 carbons, such as linear C₆H₁₂. R₁, R₂, and R₃ may improve the adhesion strength of the LOCA, whereas R₄ may help to reduce stress of the LOCA during the curing and thermal treatment. Thus, the siloxane additive of Structure 1 may allow the LOCA to have reduced internal stress, such that the bowing of the bonded substrate stack may be minimized and the optical performance of the waveguide display may not be compromised. For example, when the optical substrates include 6-inch wafers, the bow of the bonded substrate stack may be below about 20 μm, and the performance of the waveguide display may not be degraded or may only be minimally degraded. Upon curing, the mixture of the LOCA and the siloxane additive of Structure 1 may result in a permanently bonded layer with stable mechanical properties, a refractive index about 1.6 or higher at 450 nm, an absorption below about 0.1%/μm, and an adhesion strength to glass greater than about 1.5 MPa.

According to certain embodiments, an optically clear, siloxane-containing epoxy adhesive mixture for bonding two optical substrates may be cured via UV, thermal, or both UV and thermal processes to produce a high refractive index, high transparency, and low bowing bonding layer that can provide high adhesion for the bonded substrate stack. The adhesive mixture may include, for example, siloxane and epoxy-containing oligomers, a UV-activated photo-acid generator, a crosslinker additive, a solvent, and an additive of Structure 1, where the additive of Structure 1 may constitute about 1-7% of the total mass of the adhesive mixture (excluding the solvent). In the additive of Structure 1, R₁, R₂, and R₃ may include methoxide, ethoxide, propoxide, or a mixture of these materials, and R₄ may include an alkyl chain that is linear or branched and includes 2-8 carbons. The adhesive mixture, when cured, may have a refractive index between about 1.6 and about 1.7, have an optical absorption below 0.1% per micrometer of the adhesive mixture. The adhesive mixture, when applied onto 4-8 inch wafers and cured, may yield a bonded wafer stack with a bow below about 20 micrometers.

According to certain embodiments, a method of bonding two optical substrates may include spin-coating, spraying, ink-jet printing, screen-printing, or otherwise dispensing an adhesive layer including a siloxane-containing epoxy adhesive mixture onto a first substrate, and bonding the adhesive layer to a second substrate by curing the adhesive mixture via a combination of UV curing and thermal curing. The adhesive mixture may include an additive of Structure 1, where the additive of Structure 1 may constitute about 1-7% of the total mass of the mixture (excluding the solvent). The adhesive mixture may be applied onto the first substrate to form an adhesive layer with a thickness about 1-100 microns. The adhesive mixture may be cured to generate a mechanically stable adhesive layer with a refractive index between about 1.6 and about 1.7 at 450 nm, and an optical absorption below about 0.1% per micrometer of the adhesive mixture. The bonded substrate stack may have a lap shear strength of at least 2.0 MPa, and a low degree of bowing. The first substrate and the second substrate may be transparent substrates with diameters about 4 to 8 inches, and the bonded substrate stack may have a bow below 20 micrometers. At least one of the first substrate or the second substrate may be a lens with an arbitrary shape and a length about 1 to 4 inches, and the bow of the bonded substrate stack may be below about 10 micrometers.

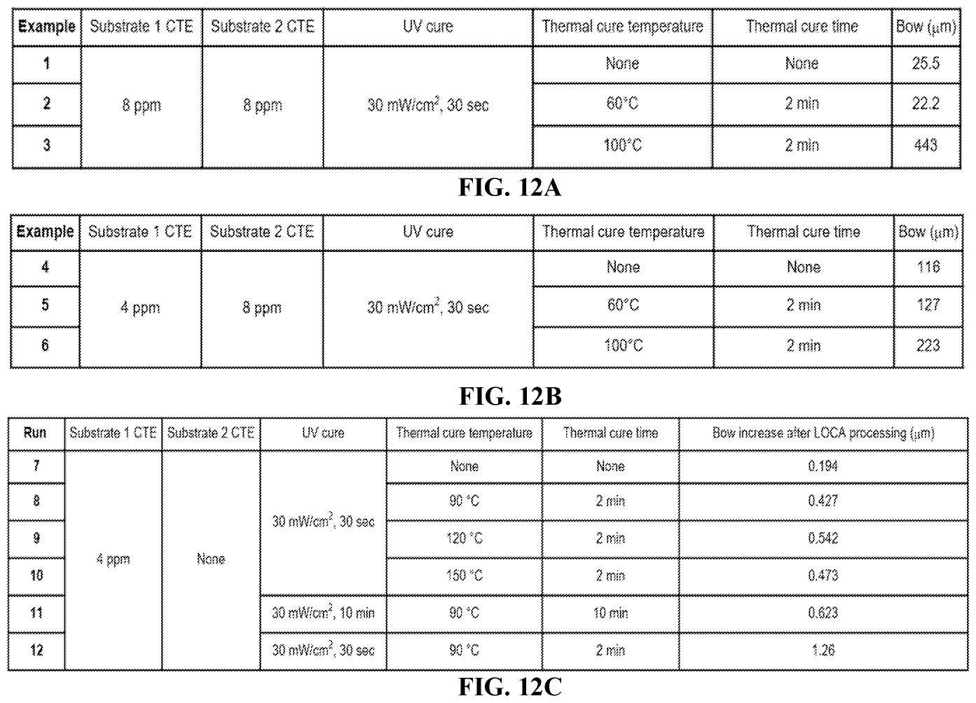

FIG. 11A illustrates an example of a process 1100 for bonding two optical substrates using a LOCA layer according to certain embodiments. As illustrates, a LOCA layer 1120 (e.g., including siloxane-containing epoxy-based LOCAs and an additive of Structure 1) may be applied onto a first optical substrate 1110 by, for example, spin-coating, spraying, ink-jet printing, screen-printing, or otherwise dispensing techniques. Any residual solvent may then be evaporated thermally, for example, by post apply bake (PAB). The LOCA may optionally be partially cured via UV treatment. A second optical substrate 1130 may then be placed above LOCA layer 1120 and first optical substrate 1110, and the substrate stack may undergo a compression bonding process by a compressor. The substrate stack including LOCA layer 1120 between first optical substrate 1110 and second optical substrate 1130 may be cured via UV curing and/or thermal curing (e.g., PEB), which may transform the LOCA material from its initial liquid state into an intermediate thermoplastic state. The substrate stack may then be baked or otherwise thermally cured to transform the LOCA material from the thermoplastic state into a final thermoset state, where the adhesion strength of the bonded stack may be maximized and the

LOCA mechanical properties may be stable against further thermal processing. Compression bonding may be applied in any or all of the curing steps.

FIG. 11B illustrates an example of the polymerization of a LOCA material including a reactive plasticizer 1152 upon UV curing. The LOCA material may include monomers or oligomers 1150, such as siloxane and epoxy-containing oligomers, which may be small molecules. The LOCA material may also include a UV-activated photo-acid generator, a crosslinker additive, a solvent, and reactive plasticizer 1152. Reactive plasticizer 1152 may have a structure as shown by Structure 1. At a molecular level, the curing process may lead to polymerization and crosslinking of the LOCA material. More specifically, upon exposure to UV light, the UV-activated photo-acid generator may generate photo-acid, which may cause the crosslinking of oligomers 1150. The crosslinked oligomers 1150 may form polymers 1160. Polymers 1160 may include a long chain of oligomers and thus may have a large molecular weight. As the chains grow, the LOCA layer may shrink. As shown in FIG. 11B, polymers 1160 may include sites 1170 that are not fully reacted. Therefore, polymers 1160 may continue to grow at sites 1170, which may crosslink the chains and build bridges between the chains. The crosslinking process of siloxane epoxy-based LOCAs may lead to significant shrinkage that may otherwise build up internal stress within the LOCA layer. However, reactive plasticizer 1152 may participate in the polymerization and/or cross-linking process and become covalently attached to the chains through covalent bonds, and may have flexible chains that may take a large variety of stable conformations while being relaxed. In other words, the flexible chains of reactive plasticizer 1152 may relax in many ways, and thus may relax more if they are in unfavorable conformations, rather than staying in the unfavorable conformations. Therefore, reactive plasticizer 1152 may allow the large molecules in the LOCA layer to rearrange and relax as the LOCA layer shrinks during the UV curing. As such, the internal stress of the LOCA layer may be reduced during the UV curing. Therefore, the bowing of the bonded substrate stack may be low during the UV curing as shown in FIG. 11A.

Similarly, during the thermal curing, as the LOCA material continues to polymerize and crosslink (e.g., at sites 1170) to form large molecules with long chains of atoms, LOCA layer 1120 may continue to shrink, and reactive plasticizer 1152 may allow the molecules to rearrange and relax as LOCA layer 1120 shrinks. Therefore, there may be little or no internal stress built up in LOCA layer 1120. Therefore, the bowing of the bonded substrate stack may be low during the thermal curing as shown in FIG. 11A. In addition, the incorporation of an appropriate amount of the reactive plasticizer (e.g., in an appropriate range) would not change the refractive index and absorption properties of the siloxane-containing epoxy polymer.

According to certain embodiments, two transparent substrates may be bonded together by a siloxane-containing epoxy adhesive layer created from a mixture including an additive of Structure 1, where the additive of Structure 1 may constitute about 1-7% of the total mass of the mixture excluding the solvent. The adhesive layer may be mechanically stable, and may have a refractive index between about 1.6 and about 1.7 at 450 nm and an optical absorption below about 0.1% per micrometer of the adhesive layer. The substrate stack bonded by the adhesive layer may have a lap shear strength of at least 2.0 MPa, and may have a low degree of bowing. In one example, the two transparent substrates may be wafers with diameters about 4 to 8 inches, and the bonded substrate stack may have a bow below 20 micrometers. In some embodiments, at least one of the two transparent substrates is a lens having an arbitrary shape and a length about 1 to 4 inches, and the bow of the bonded substrate stack is below 10 micrometers.

### EXAMPLES

In all examples described below, a siloxane-containing epoxy-based adhesive as described above was used. The adhesive includes a mixture of methyl and phenyl siloxanes oligomers terminated by epoxy functionalities. The adhesive also includes a UV-activated photo-acid generator and a crosslinker additive. The siloxane-containing epoxy-based LOCA was dissolvent in propylene glycol methyl ether acetate (PGMEA) solvent and the solution was spin-coated onto a 6-inch optical substrate., The siloxane-containing epoxy-based adhesive used in Examples 1-12 may not include a reactive plasticizer, whereas the siloxane-containing epoxy-based adhesive used in Examples 13-24 may include a reactive plasticizer.

### A. Comparative Examples 1-3

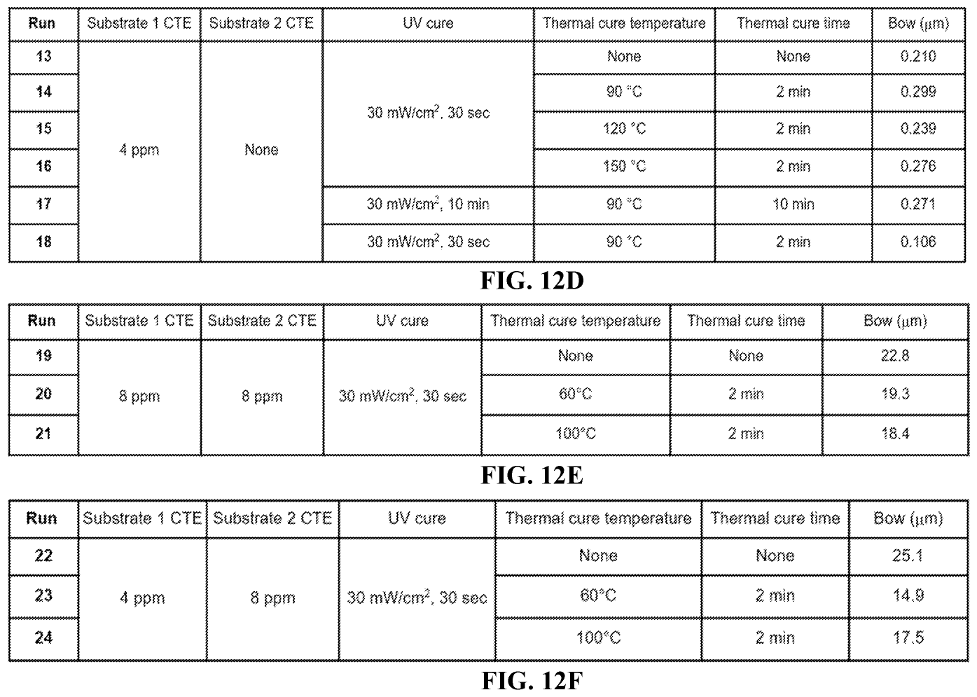

FIG. 12A shows substrate bowing of examples 1-3 of substrate stacks bonded using LOCAs that are cured by different curing processes. In the example shown in FIG. 12A, the solution including a siloxane-containing epoxy-based LOCA was spin-coated onto a first optical substrate that has a diameter about 6 inches and a CTE about 8 ppm. The solvent was removed from the LOCA by baking the first optical substrate at about 90° C. for about 2 minutes. A second optical substrate with a diameter about 6 inches and a CTE about 8 ppm was placed on the LOCA coated on the first optical substrate. Prior to bonding, both optical substrates to be bonded have a substrate bowing below 5 μm. The substrate stack was compression bonded as described above with respect to, for example, FIGS. 9A and 11A. The substrate stack was then exposed to a UV excitation source with a power of 30 mW/cm₂, such that the LOCA material may be crosslinked. The refractive index of the LOCA layer was 1.6 at 450 nm (as measured by ellipsometry), and the LOCA absorption was <0.1%/μm.

In Example 1, the bow of the bonded substrate stack increased to 25 μm after UV curing, even in the absence of any thermal curing. This shows that the LOCA coating and initial crosslinking via UV curing can increase the bowing of the bonded substrate stack. Since no thermal curing was performed, the substrate bowing may be due to the increase of the internal stress caused by the LOCA material drying and shrinkage during the UV curing. Examples 2-3 show that further crosslinking via thermal curing (e.g., at 100° C.) can lead to a dramatic increase in substrate bowing due to further LOCA shrinkage and internal stress build-up. Since the two substrates have the same CTE, the LOCA internal stress may be the main contributor to the substrate bowing after the bonding process is completed.

### B. Comparative Examples 4-6

FIG. 12B shows substrate bowing of Examples 4-6 of substrate stacks bonded using LOCAs that are cured by different curing processes. Examples 4-6 were made using processes similar to the processes for making Examples 1-3 described above, but the two 6-inch optical substrates bonded using the LOCAs have different CTEs. As shown by FIG. 12B, UV curing led to higher substrate bowing (e.g., about 116 μm) in the bonded substrate stack, and further thermal curing resulted in further increase in substrate bowing. The CTE mismatch and the lower CTE of the first optical substrate may contribute to the differences in substrate bow values, when compared with Examples 1-3. The fact that the substrate bowing was significantly above 20 μm even when no thermal curing was applied as show by Example 4 shows that the contribution to substrate bowing by LOCA internal stress is significant.

### C. Comparative Examples 7-12

FIG. 12C shows substrate bowing of Examples 7-12 of substrates with LOCA coatings that are cured by different curing processes. In Examples 7-12, the solution including the siloxane-containing epoxy-based LOCA was spin-coated onto a first optical substrate that has a diameter about 6 inches and a CTE about 4 ppm. The solvent was removed from the LOCA by baking the first optical substrate at about 90° C. for about 2 minutes. The first optical substrate with the LOCA coating was then exposed to a UV excitation source with a power of 30 mW/cm², such that the LOCA material may be crosslinked. The first optical substrate with the LOCA coating was not bonded to a second optical substrate. The substrate bow was measured prior to coating and after the LOCA processing, and the changes in substrate bowing are shown in FIG. 12C. As shown by Examples 7-12, the substrate bowing increases after LOCA coating and UV curing. The substrate bowing may further increase as the thermal curing temperature and time are increased. These examples show that complete curing and crosslinking of the LOCA may lead to increase in substrate bowing. The absence of a second optical substrate indicates that substrate bowing takes place even when CTE mismatch between two substrates is not a contributor to the deformation during LOCA curing.

### D. Working Examples 13-18

FIG. 12D shows substrate bowing of Examples 13-18 of substrates with LOCA coatings that include a reactive plasticizer according to certain embodiments. In Examples 13-18, a siloxane-containing epoxy-based LOCA was mixed with an additive of Structure 1 and was dissolvent in PGMEA solvent to form a solution. The ratio of LOCA to additive was 95:5 by weight. In all cases, incorporation of the additive does not change the LOCA optical properties (e.g., a refractive index of 1.6 RI as measured by ellipsometry and LOCA absorption <0.1%/μm of LOCA thickness). The solution may be spin-coated onto a first optical substrate that has a diameter about 6 inches and a CTE about 4 ppm. The solvent was removed from the LOCA by baking the first optical substrate at about 90° C. for about 2 minutes. The first optical substrate with the LOCA coating was then exposed to a UV excitation source with a power of 30 mW/cm², such that the LOCA material may be crosslinked. The LOCA curing conditions in Examples 13-18 are the same as for Examples 7-12. The first optical substrate with the LOCA coating was not bonded to a second optical substrate. The substrate bow was measured prior to coating and after the LOCA processing, and the changes in substrate bowing are shown in FIG. 12D. FIG. 12D shows that the use of the additive of Structure 1 drastically reduces changes in substrate bow during thermal curing. Furthermore, it is possible to apply a long thermal cure process as shown by Example 18, to reduce internal stress via film relaxation. These examples show that the internal stress of the siloxane epoxy-based LOCA can be reduced during thermal curing without affecting optical properties, when the additive of Structure 1 is used in the mixture.

### E. Working Examples 19-21

FIG. 12E shows substrate bowing of Examples 19-21 of substrate stacks bonded using LOCAs that include a reactive plasticizer according to certain embodiments. In Examples 19-21, a siloxane-containing epoxy-based LOCA was mixed with an additive of Structure 1 and was dissolvent in PGMEA solvent to form a solution. The ratio of LOCA to additive was 95:5 by weight. The solution may be spin-coated onto a first optical substrate that has a diameter about 6 inches and a CTE about 8 ppm. The solvent may be removed from the LOCA by baking the first optical substrate, for example, at about 90° C. for about 2 minutes. A second optical substrate with a diameter about 6 inches and a CTE about 8 ppm was placed on the LOCA coated on the first optical substrate. Prior to bonding, both optical substrates to be bonded had a substrate bowing below 5 μm. The substrate stack was compression bonded as described above with respect to, for example, FIGS. 9A and 11A. The substrate stack was then exposed to a UV excitation source with a power of 30 mW/cm², such that the LOCA material may be crosslinked. The substrate stack may also be thermally cured. Incorporation of the additive does not change the LOCA optical properties (e.g., a refractive index of 1.6 RI as measured by ellipsometry and LOCA absorption <0.1%/μm of LOCA thickness). FIG. 12E shows that the additive results in minimal change in the bowing of the bonded stack upon thermal curing. Furthermore, the adhesion strength between the two substrates in Examples 20-21 are 4.0 Mpa, as measured by lap-shear. This shows that two optical substrates can be bonded with the siloxane mixture, and the thermal cure process can be performed without increasing the bonded stack bowing to be above 20 μm.

### F. Working Examples 22-24

FIG. 12F shows substrate bowing of Examples 22-24 of substrate stacks bonded using LOCAs that include a reactive plasticizer according to certain embodiments. Examples 22-24 are made using processes similar to the processes for making Examples 19-21 described above, but the two 6-inch optical substrates bonded using the LOCAs have different CTEs. The siloxane-containing epoxy-based LOCA was mixed with an additive of Structure 1 and was dissolvent in PGMEA solvent to form a solution. The ratio of LOCA to additive was 95:5 by weight. FIG. 12F shows that the additive results in minimal change in the bowing of the bonded stack upon thermal curing, even when there is a CTE mismatch between the two optical substrates. Furthermore, it was found that the LOCA optical properties were unchanged by the incorporation of the stress-reduction additive: the refractive index of LOCA is 1.6 as measured by ellipsometry and the LOCA absorption is less than 0.1%/μm of LOCA thickness. This further shows that, using siloxane-containing epoxy-based LOCA with the additive of Structure 1, two optical substrates can be bonded with the siloxane mixture, and the thermal cure process can be performed without increasing the bonded stack bow above 20 μm.

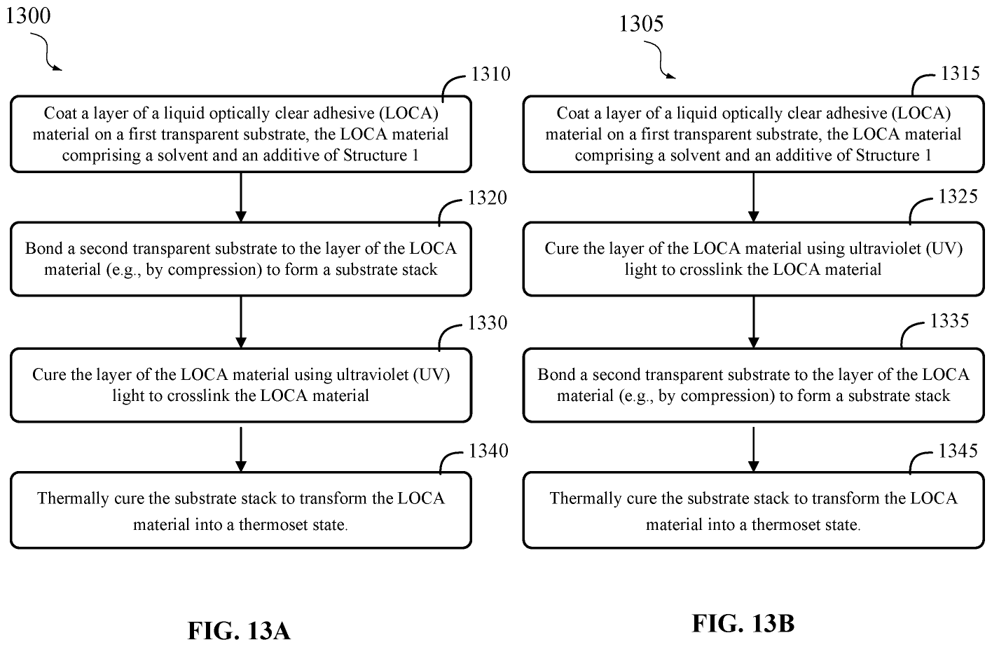

FIG. 13A includes a flowchart 1300 illustrating an example of a process of bonding optical substrates that are transparent to visible light according to certain embodiments. It is noted that the specific operations illustrated in FIG. 13A provide a particular process of bonding optical substrates. Other sequences of operations may be performed according to alternative embodiments. Moreover, the individual operations illustrated in FIG. 13A may include multiple sub-steps that may be performed in various sequences as appropriate to the individual operation. Furthermore, additional operations may be added or some operations may not be performed depending on the particular applications. One of ordinary skill in the art would recognize many variations, modifications, and alternatives.

Operations in block 1310 may include coating a layer of a LOCA material on a first transparent substrate, the LOCA material comprising a solvent and an additive of Structure 1:

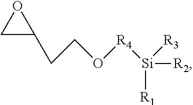

where R₁, R₂, and R₃ include methoxide, ethoxide, propoxide, or a combination thereof, R₄ includes an alkyl chain that is linear or branched and includes 2-8 carbons (e.g., linear C₆H₁₂), and the additive of Structure 1 constitutes 1-7% of a total mass of the LOCA material excluding the solvent. The solvent may include PGMEA, dipropylene glycol methyl ether (DPGME)/tripropylene glycol monomethyl ether (TPM), or a combination. The LOCA material may also include siloxane and epoxy-containing oligomers, a UV-activated photo-acid generator, and a cross-linker additive. Coating the layer of the LOCA material may include spin-coating, spraying, ink-jet printing, screen-printing, or dispensing. A thickness of the layer of the LOCA material may be between 1 and 100 microns.

Operations in block 1320 may include bonding a second transparent substrate to the layer of the LOCA material (e.g., by compression) to form a substrate stack. Operations in block 1330 may include curing the layer of the LOCA material using ultraviolet (UV) light to crosslink the LOCA material. Operations in block 1340 may include thermally curing the substrate stack to transform the LOCA material into a thermoset state. In some embodiments, compression may be applied to the substrate stack in any or all curing operations. After thermally curing the substrate stack, the layer of the LOCA material may be characterized by a refractive index greater than 1.6 at 450 nm and an optical absorption below 0.1% per micrometer of a thickness of the layer of the LOCA material, and the substrate stack may be characterized by a lap shear strength greater than 1.5 MPa, or greater than about 2 MPa, such as about 4 MPa. In some embodiments, the first transparent substrate and the second transparent substrate are substrates with diameters between 4 and 8 inches, and after thermally curing the substrate stack, a bow of the substrate stack is less than 20 μm. In some embodiments, at least one of the first transparent substrate or the second transparent substrate is a lens of an arbitrary shape and a length of 1 to 4 inches, and after thermally curing the substrate stack, a bow of the substrate stack is less than 10 μm.

FIG. 13B includes a flowchart 1305 illustrating another example of a process of bonding optical substrates that are transparent to visible light according to certain embodiments. Operations in block 1315 may include coating a layer of a LOCA material on a first transparent substrate, the LOCA material comprising a solvent and an additive of Structure 1, where the additive of Structure 1 may constitute 1-7% of a total mass of the LOCA material excluding the solvent. The solvent may include PGMEA, DPGME/TPM, or a combination. The LOCA material may also include siloxane and epoxy-containing oligomers, a UV-activated photo-acid generator, and a cross-linker additive. Coating the layer of the LOCA material may include spin-coating, spraying, ink-jet printing, screen-printing, or dispensing. A thickness of the layer of the LOCA material may be between 1 and 100 microns.

Operations in block 1325 may include curing the layer of the LOCA material using UV light to crosslink the LOCA material. Operations in block 1335 may include bonding a second transparent substrate to the layer of the LOCA material (e.g., by compression) to form a substrate stack. Operations in block 1345 may include thermally curing the substrate stack to transform the LOCA material into a thermoset state. In some embodiments, compression may be applied in any or all curing operations. After thermally curing the substrate stack, the layer of the LOCA material may be characterized by a refractive index greater than 1.6 at 450 nm and an optical absorption below 0.1% per micrometer of a thickness of the layer of the LOCA material, and the substrate stack may be characterized by a lap shear strength greater than 1.5 MPa, or greater than about 2 MPa, such as about 4 MPa. In some embodiments, the first transparent substrate and the second transparent substrate are substrates with diameters between 4 and 8 inches, and after thermally curing the substrate stack, a bow of the substrate stack is less than 20 μm. In some embodiments, at least one of the first transparent substrate or the second transparent substrate is a lens of an arbitrary shape and a length of 1 to 4 inches, and after thermally curing the substrate stack, a bow of the substrate stack is less than 10 μm.

Embodiments of the invention may include or be implemented in conjunction with an artificial reality system. Artificial reality is a form of reality that has been adjusted in some manner before presentation to a user, which may include, for example, a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

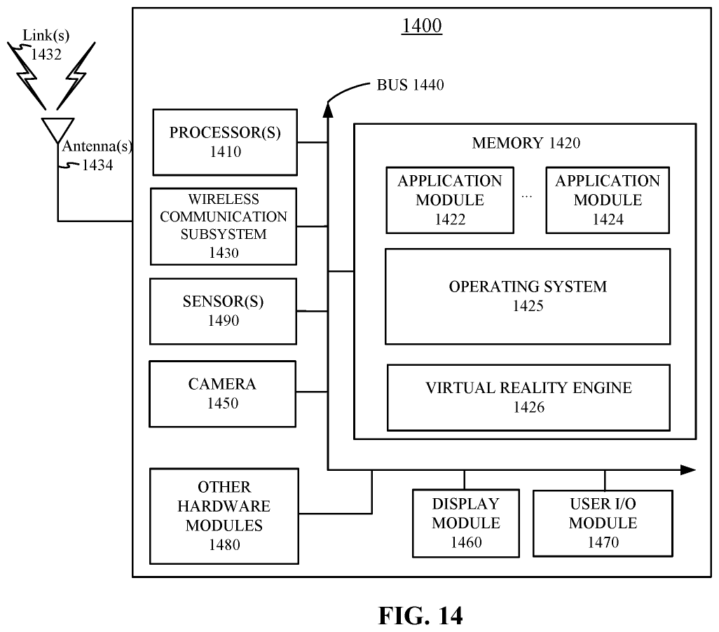

FIG. 14 is a simplified block diagram of an electronic system 1400 of an example of a near-eye display (e.g., HMD device) for implementing some of the examples disclosed herein. Electronic system 1400 may be used as the electronic system of an HMD device or other near-eye displays described above. In this example, electronic system 1400 may include one or more processor(s) 1410 and a memory 1420. Processor(s) 1410 may be configured to execute instructions for performing operations at a number of components, and can be, for example, a general-purpose processor or microprocessor suitable for implementation within a portable electronic device. Processor(s) 1410 may be communicatively coupled with a plurality of components within electronic system 1400. To realize this communicative coupling, processor(s) 1410 may communicate with the other illustrated components across a bus 1440. Bus 1440 may be any subsystem adapted to transfer data within electronic system 1400. Bus 1440 may include a plurality of computer buses and additional circuitry to transfer data.

Memory 1420 may be coupled to processor(s) 1410. In some embodiments, memory 1420 may offer both short-term and long-term storage and may be divided into several units. Memory 1420 may be volatile, such as static random access memory (SRAM) and/or dynamic random access memory (DRAM) and/or non-volatile, such as read-only memory (ROM), flash memory, and the like. Furthermore, memory 1420 may include removable storage devices, such as secure digital (SD) cards. Memory 420 may provide storage of computer-readable instructions, data structures, program modules, and other data for electronic system 1400. In some embodiments, memory 1420 may be distributed into different hardware modules. A set of instructions and/or code might be stored on memory 1420. The instructions might take the form of executable code that may be executable by electronic system 1400, and/or might take the form of source and/or installable code, which, upon compilation and/or installation on electronic system 1400 (e.g., using any of a variety of generally available compilers, installation programs, compression/decompression utilities, etc.), may take the form of executable code.

In some embodiments, memory 1420 may store a plurality of application modules 1422 through 1424, which may include any number of applications. Examples of applications may include gaming applications, conferencing applications, video playback applications, or other suitable applications. The applications may include a depth sensing function or eye tracking function. Application modules 1422-1424 may include particular instructions to be executed by processor(s) 1410. In some embodiments, certain applications or parts of application modules 1422-1424 may be executable by other hardware modules 1480. In certain embodiments, memory 1420 may additionally include secure memory, which may include additional security controls to prevent copying or other unauthorized access to secure information.

In some embodiments, memory 1420 may include an operating system 1425 loaded therein. Operating system 1425 may be operable to initiate the execution of the instructions provided by application modules 1422-1424 and/or manage other hardware modules 1480 as well as interfaces with a wireless communication subsystem 1430 which may include one or more wireless transceivers. Operating system 1425 may be adapted to perform other operations across the components of electronic system 1400 including threading, resource management, data storage control and other similar functionality.

Wireless communication subsystem 1430 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 1400 may include one or more antennas 1434 for wireless communication as part of wireless communication subsystem 1430 or as a separate component coupled to any portion of the system. Depending on desired functionality, wireless communication subsystem 1430 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 1430 may permit data to be exchanged with a network, other computer systems, and/or any other devices described herein. Wireless communication subsystem 1430 may include a means for transmitting or receiving data, such as identifiers of HMD devices, position data, a geographic map, a heat map, photos, or videos, using antenna(s) 1434 and wireless link(s) 1432.

Embodiments of electronic system 1400 may also include one or more sensors 1490. Sensor(s) 1490 may include, for example, an image sensor, an accelerometer, a pressure sensor, a temperature sensor, a proximity sensor, a magnetometer, a gyroscope, an inertial sensor (e.g., a module that combines an accelerometer and a gyroscope), an ambient light sensor, or any other similar module operable to provide sensory output and/or receive sensory input, such as a depth sensor or a position sensor. For example, in some implementations, sensor(s) 1490 may include one or more inertial measurement units (IMUs) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or some combination thereof. The position sensors may be located external to the IMU, internal to the IMU, or some combination thereof. At least some sensors may use a structured light pattern for sensing.

Electronic system 1400 may include a display module 1460. Display module 1460 may be a near-eye display, and may graphically present information, such as images, videos, and various instructions, from electronic system 1400 to a user. Such information may be derived from one or more application modules 1422-1424, virtual reality engine 1426, one or more other hardware modules 1480, a combination thereof, or any other suitable means for resolving graphical content for the user (e.g., by operating system 1425). Display module 1460 may use liquid crystal display (LCD) technology, light-emitting diode (LED) technology (including, for example, OLED, ILED, μLED, AMOLED, TOLED, etc.), light emitting polymer display (LPD) technology, or some other display technology.

Electronic system 1400 may include a user input/output module 1470. User input/output module 1470 may allow a user to send action requests to electronic system 1400. An action request may be a request to perform a particular action. For example, an action request may be to start or end an application or to perform a particular action within the application. User input/output module 1470 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 1400. In some embodiments, user input/output module 1470 may provide haptic feedback to the user in accordance with instructions received from electronic system 1400. For example, the haptic feedback may be provided when an action request is received or has been performed.

Electronic system 1400 may include a camera 1450 that may be used to take photos or videos of a user, for example, for tracking the user's eye position. Camera 1450 may also be used to take photos or videos of the environment, for example, for VR, AR, or MR applications. Camera 1450 may include, for example, a complementary metal—oxide—semiconductor (CMOS) image sensor with a few millions or tens of millions of pixels. In some implementations, camera 1450 may include two or more cameras that may be used to capture 3-D images.

In some embodiments, electronic system 1400 may include a plurality of other hardware modules 1480. Each of other hardware modules 1480 may be a physical module within electronic system 1400. While each of other hardware modules 1480 may be permanently configured as a structure, some of other hardware modules 1480 may be temporarily configured to perform specific functions or temporarily activated. Examples of other hardware modules 1480 may include, for example, an audio output and/or input module (e.g., a microphone or speaker), a near field communication (NFC) module, a rechargeable battery, a battery management system, a wired/wireless battery charging system, etc. In some embodiments, one or more functions of other hardware modules 1480 may be implemented in software.

In some embodiments, memory 1420 of electronic system 1400 may also store a virtual reality engine 1426. Virtual reality engine 1426 may execute applications within electronic system 1400 and receive position information, acceleration information, velocity information, predicted future positions, or some combination thereof of the HMD device from the various sensors. In some embodiments, the information received by virtual reality engine 1426 may be used for producing a signal (e.g., display instructions) to display module 1460. For example, if the received information indicates that the user has looked to the left, virtual reality engine 1426 may generate content for the HMD device that mirrors the user's movement in a virtual environment. Additionally, virtual reality engine 1426 may perform an action within an application in response to an action request received from user input/output module 1470 and provide feedback to the user. The provided feedback may be visual, audible, or haptic feedback. In some implementations, processor(s) 1410 may include one or more GPUs that may execute

In various implementations, the above-described hardware and modules may be implemented on a single device or on multiple devices that can communicate with one another using wired or wireless connections. For example, in some implementations, some components or modules, such as GPUs, virtual reality engine 1426, and applications (e.g., tracking application), may be implemented on a console separate from the head-mounted display device. In some implementations, one console may be connected to or support more than one HMD.

In alternative configurations, different and/or additional components may be included in electronic system 1400. Similarly, functionality of one or more of the components can be distributed among the components in a manner different from the manner described above. For example, in some embodiments, electronic system 1400 may be modified to include other system environments, such as an AR system environment and/or an MR environment.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium,” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or a combination of A, B, and/or C, such as AB, AC, BC, AA, ABC, AAB, ACC, AABBCCC, or the like.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A liquid optically clear adhesive (LOCA) for bonding optical substrates, the LOCA comprising:
siloxane and epoxy-containing oligomers;
a UV-activated photo-acid generator;
a cross-linker additive;
a solvent; and
an additive of Structure 1: 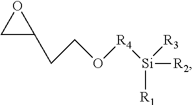
wherein the additive of Structure 1 constitutes 1-7% of a total mass of the LOCA excluding the solvent.

2. The LOCA of claim 1, wherein R₁, R₂, and R₃ include methoxide, ethoxide, propoxide, or a combination thereof.

3. The LOCA of claim 1, wherein R₄ includes an alkyl chain that is linear or branched and includes 2-8 carbons.

4. The LOCA of claim 1, wherein R₄ includes linear C₆H₁₂.

5. The LOCA of claim 1, wherein, when cured, the LOCA has a refractive index equal to or greater than 1.6 at 450 nm and an optical absorption below 0.1% per micrometer of a thickness of the LOCA.

6. The LOCA of claim 1, wherein the LOCA is curable by ultraviolet light, heat, or both ultraviolet light and heat.

7. The LOCA of claim 1, wherein the LOCA, when applied onto two 4-8 inch substrates and cured, yields a bonded stack with a bow below 20 micrometers.

8. The LOCA of claim 1, wherein the LOCA, when applied onto two glass substrates and cured, yields a bonded substrate stack with a lap shear strength greater than 1.5 MPa.

9. A method comprising:
coating a layer of a liquid optically clear adhesive (LOCA) material on a first transparent substrate, the LOCA material comprising a solvent and an additive of Structure 1: 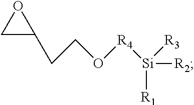
bonding a second transparent substrate to the layer of the LOCA material by compression to form a substrate stack;
curing the substrate stack using ultraviolet (UV) light to crosslink the LOCA material; and
thermally curing the substrate stack to transform the LOCA material into a thermoset state.

10. The method of claim 9, wherein the LOCA material includes a siloxane-containing epoxy adhesive.

11. The method of claim 9, wherein:
the additive of Structure 1 constitutes 1-7% of a total mass of the LOCA material;
R₁, R₂, and R₃ include methoxide, ethoxide, propoxide, or a combination thereof; and
R₄ includes an alkyl chain that is linear or branched and includes 2-8 carbons.

12. The method of claim 9, wherein, after thermally curing the substrate stack:
the layer of the LOCA material is characterized by a refractive index equal to or greater than 1.6 at 450 nm and an optical absorption below 0.1% per micrometer of a thickness of the layer of the LOCA material, and
the substrate stack is characterized by a lap shear strength greater than 1.5 MPa.

13. The method of claim 9, wherein:
the first transparent substrate and the second transparent substrate are substrates with diameters between 4 and 8 inches; and
after thermally curing the substrate stack, a bow of the substrate stack is less than 20 μm.

14. A device comprising:
a layer stack comprising two transparent substrates bonded together by a siloxane-containing epoxy adhesive layer,
wherein the siloxane-containing epoxy adhesive layer includes an additive of Structure 1: 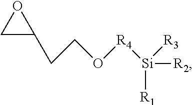
wherein the additive of Structure 1 constitutes 1-7% of a total mass of the siloxane-containing epoxy adhesive layer.

15. The device of claim 14, wherein R₁, R₂, and R₃ include methoxide, ethoxide, propoxide, or a combination thereof.

16. The device of claim 14, wherein R₄ includes an alkyl chain that is linear or branched and includes 2-8 carbons.

17. The device of claim 14, wherein the siloxane-containing epoxy adhesive layer is characterized by a refractive index equal to or greater than 1.6 at 450 nm and an optical absorption below 0.1% per micrometer of a thickness of the siloxane-containing epoxy adhesive layer.

18. The device of claim 14, wherein:
a thickness of the siloxane-containing epoxy adhesive layer is between 1 and 100 microns; and
the layer stack is characterized by a lap shear strength greater than 1.5 MPa.

19. The device of claim 14, wherein:
the two transparent substrates are substrates with diameters between 4 and 8 inches; and
a bow of the layer stack is less than 20 μm.

20. The device of claim 14, wherein:
at least one of two transparent substrates is a lens of an arbitrary shape and with a length of 1 to 4 inches; and
a bow of the layer stack is less than 10 μm.
